(19) United States
(12) Patent Application Publication
(10) Pub. No.: US 2014/0164171 A1
(43) Pub. Date: Jun. 12, 2014

(54) SYSTEM AND METHOD FOR AUTOMATIC SEGMENTATION AND MATCHING OF CUSTOMERS TO VENDIBLE ITEMS

(71) Applicants: Tian Lu, Toronto (CA); Craig Edgar Boutilier, Toronto (CA)

(72) Inventors: Tian Lu, Toronto (CA); Craig Edgar Boutilier, Toronto (CA)

(21) Appl. No.: 14/001,972

(22) PCT Filed: Sep. 11, 2012
(86) PCT No.: PCT/CA2012/000833

§ 371 Date: Dec. 23, 2013

Related U.S. Application Data
(60) Provisional application No. 61/533,479, filed on Sep. 12, 2011.

(51) Int. Cl. G06Q 30/06

(52) U.S. Cl. CPC G06Q 30/0631
USPC 705/26.7

(57) ABSTRACT

A computer implemented method and system of providing an optimal matching of customer preference sets to vendible items using an objective function that measures utility of one or more customers associated with the customer preference sets.

### PRIORITY

This application claims the benefit of U.S. Provisional Patent Application Ser. No. 61/533,479 filed on Sep. 12, 2011, by the present inventors, and entitled “System and Method For Automatic Segmentation and Matching Customers Faced With Multiple Volume-Based Discounts”, the entire contents of which are hereby incorporated by reference herein for all purposes.

### FIELD

The embodiments disclosed herein relate to the automated elicitation of customer preferences for goods or services offered for sale by vendors who propose volume-based or other forms of group discounts; and the matching of customer preferences to items offered by the vendors in a way that is sensitive to individual customer preferences.

### INTRODUCTION

Consumers and businesses (hereafter customers) searching for desired products or services (hereafter vendible items) are frequently confronted with a choice of items or vendors offering items of greater of lesser desirability. Customers are often faced with a trade-off between the overall desirability of a specific item offered by some vendor and the price. Matching customers (or preferences associated with customers) to items (or to specific vendors of items) is a problem in economics and market design. There exists a need for improved systems and methods for matching customers with items, or at least an alternative system.

### SUMMARY

According to some embodiments, there is provided a computer implemented method of providing a matching of customer preference sets to vendible items, wherein the computer comprises a processor and a memory coupled to the processor and configured to store instructions executable by the processor to perform the method comprising: receiving a pricing schedule for each of at least two vendible items, wherein at least one of the pricing schedules comprises at least one nontrivial pricing condition for the respective vendible item, and, for each pricing condition, a corresponding price for the respective vendible item; receiving at least two customer preference sets from a customer group comprising at least one customer, wherein each customer preference set describes a customer preference for purchasing one or more units of at least one of the at least two vendible items; determining an objective function, wherein the objective function measures utility of the customer group when one or more received customer preference sets is matched to zero or more units of zero or more vendible items of the at least two vendible items, wherein the objective function measures the utility based on the customer preference sets and the pricing schedules; determining, using the objective function, an optimal matching of one or more customer preference sets to zero or more units of zero or more vendible item of the at least two vendible items, wherein the matching comprises, for each customer preference set that is matched to the one or more units of at least one vendible item, a price to be paid for the respective matched units, wherein the price is based on the pricing schedule for the respective matched at least one vendible item; and making the matching electronically available.

In accordance with some embodiments, each customer preference set may correspond to a customer of the customer group, wherein utility of a customer is a value the customer realizes from purchasing the zero or more units matched to each customer preference set corresponding to that customer at the price to be paid for the respective matched units, wherein the utility of the customer group is based on the utility of the customers of the customer group.

In accordance with some embodiments, a customer preference set comprises a preference to purchase at least one vendible item over at least one other vendible item. In accordance with some embodiments, the customer preference set comprises a preference to purchase at least one vendible item at a particular price over at least one other vendible item at a particular price.

In accordance with some embodiments, the objective function may comprise one or more constraints to preclude one or more matchings of customer preference sets to units of vendible items from being an optimal matching. The constraints may be selected from the group of constraints consisting of customer budgetary constraints, customer capacity constraints, vendible item capacity constraints, vendible item budgetary constraints.

In accordance with some embodiments, the objective function maximizes the utility of the customer group, wherein the utility of the customer group comprises a sum of utilities of all customers.

The objective function may comprise one or more constraints to preclude one or more matchings of customer preference sets to units of vendible items from being an optimal matching.

In accordance with some embodiments, the maximization is an approximate maximization which permits the utility of the customer group to be less than a maximum achievable utility of the customer group by at most some threshold.

In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units.

In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have myopic stability and may be individual surplus maximizing, where the maximization is subject to a constraint that no customer would achieve a higher utility if at least one of the customer preference sets corresponding to that customer were matched to one or more units of one or more vendible items, different than the zero or more units matched to that customer preference set, at the price to be paid for the respective matched units. In accordance with some embodiments, the maximization constraint is approximate such that the utility of a customer that would be attained by matching at least one of the customer preference sets corresponding to that customer to one or more units of one of more products, different than the zero or more units matched to that customer preference set, at the prices of the matching, is greater than the utility of the customer determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have Nash or triggered stability wherein the maximization is subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to the different items. In accordance with some embodiments, the maximization constraint is approximate such that the utility of a customer that would be attained if at least one of the customer preference sets corresponding to that customer were matched to one or more units of one or more vendible items, different than the zero or more units matched to that customer preference set, at the prices of the different vendible items that would be paid had that customer preference set been matched to said different items, is greater than the utility of the customer determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have group stability the maximization is subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items. In accordance with some embodiments, the maximization constraint is approximate such that the utility that the group of two or more customers would individually or collectively achieve, if at least one customer preference set corresponding to each customer in the group were matched to one or more units of one or more vendible items, different than the zero or more units matched to said customer preference sets, at the prices of the different vendible items that would be paid had said customer preference set been matched to said different items, is greater than the individual or collective utility attained by the customers of the group determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the price to be paid by for each unit of the at least two vendible items to which a customer preference set is matched is personalized, and may be different from other prices to be paid for each unit of the at least two vendible items by other customer preference sets, and may be different from the prices of the pricing schedule. The personalized prices may be computed by: computing subsidies to be paid to one or more customers for the one or more units of the items to which one or more of the customer preference sets associated with the customer are matched, wherein this subsidy will be applied to reduce the price, for each unit of the matched vendible items, or collectively for all units, by the amount of the subsidies computed for said customer; computing contributions to be paid by one or more customers for the one or more units of the items to which one or more customer preference sets associated with the customer are matched, wherein these contributions will be applied to increase the price, for each unit of the matched vendible items, or collectively for all matched units, by the amount of the contributions computed for said customer; and where the total of all subsidies does not exceed the total of all contributions. The personalized prices may be computed by transferring contributions and subsidies between customers, wherein the objective function minimizes a total of all contributions and subsidies transferred.

In accordance with some embodiments with personalized prices, the matching may have myopic stability and the maximization may be subject to a constraint that no customer would achieve a higher utility if at least one of the customer preference sets corresponding to that customer were matched to one or more units of one or more vendible items, different than the zero or more units matched to that customer preference set, at the price to be paid for the respective matched units.

In accordance with some embodiments with personalized prices, the matching may have Nash or triggered stability, and the maximization may be subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to said different items.

In accordance with some embodiments with personalized prices, the matching may have group stability and the maximization may be subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items. In accordance with some embodiments, the maximization constraint is approximate such that the utility that the customer would attain if at least one of the customer preference sets corresponding to that customer were matched to one or more units of one or more vendible items different than the zero or more units matched to that customer preference set, is greater than the utility of the customer determined by the matching by no more than a threshold.

In accordance with some embodiments, the matching is stable and the objective function optimizes the utility of the customer group subject to a constraint that no customer would achieve a higher utility if at least one of the customer preference sets corresponding to that customer were matched to one or more units of one or more vendible items, different than the zero or more units matched to that customer preference set, at the price to be paid for the respective matched units. In accordance with some embodiments, the optimization constraint is approximate such that a utility of the customer that would be attained by matching at least one of the customer preference sets corresponding to that customer to one or more units of one of more items, different than the zero or more units matched to that customer preference set, at the prices of the matching, is greater than the utility of the customer determined by the matching by no more than a threshold.

In accordance with some embodiments, the matching is stable and the objective function optimizes the utility of the customer group subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to said different items. In accordance with some embodiments, the maximization constraint is approximate such that the utility of a customer that would be attained if at least one of the customer preference sets corresponding to that customer were matched to one or more units of one or more vendible items, different than the zero or more units matched to that customer preference set, at the prices of the different vendible items that would be paid had that customer preference set been matched to said different items, is greater than the utility of the customer determined by the matching by no more than a threshold.

In accordance with some embodiments, the matching is stable and the objective function optimizes the utility of the customer group subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items. In accordance with some embodiments, the optimization constraint is approximate such that the utility that the group of two or more customers would individually or collectively achieve, if at least one customer preference set corresponding to each customer in the group were matched to one or more units of one or more vendible items, different than the zero or more units matched to said customer preference sets, at the prices of the different vendible items that would be paid had said customer preference set been matched to said different items, is greater than the individual or collective utility attained by the customers of the group determined by the matching by no more than a threshold.

In accordance with some embodiments involving a stable matching, the customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for zero or more units matched to each customer preference set and the price to be paid for the respective matched units.

In accordance with some embodiments involving a stable matching, the optimization is an approximate optimization which permits the utility of the customer group to be different than a best utility of the customer group by at most some threshold. In accordance with some embodiments involving a stable matching, the objective function comprises one or more constraints to preclude one or more matchings of customer preference sets to units of vendible items from being an optimal matching.

In accordance with some embodiments, a deal is a combination of one or more units of a vendible item and a particular price for the one or more units of the vendible item, where at least one customer preference set comprises at least one of a ranking, rating, and scoring of one or more deals, wherein the utility of a customer is based on the at least one of the ranking, rating and scoring of deals.

In accordance with some embodiments involving deals, the method further comprises determining one or more available deals based on the pricing schedules received for the vendible items and the matching of each customer preference set to zero or more units of zero or more vendible items, where the objective function optimizes the utility of the customer group subject to a constraint that no customer would achieve a higher utility if at least one of the customer preference sets corresponding to that customer were matched to one or more units of one or more vendible items, different than the zero or more units matched to that customer preference set, at the price to be paid for the respective matched units corresponding to the available deals.

In accordance with some embodiments involving deals, the objective function may optimize the utility of the customer group subject to a constraint that no customer would achieve higher utility if at least one of the customer preference sets corresponding to that customer were matched to one or more units of one or more vendible items, different than the zero or more units matched to that customer preference set, at prices of the different vendible items corresponding to the deals that would have been available had that customer preference set been matched to said different items.

In accordance with some embodiments involving deals, the objective function may optimize the utility of the customer group subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items corresponding to the deals that would have been available had said customer preference sets been matched to said different items.

In accordance with some embodiments, the method may further comprise: determining if the matching satisfies a quality measure; determining if a termination condition is met, wherein the termination condition comprises the quality measure; upon determining that the termination condition is met, terminating with the matching; upon determining that the termination condition is not met, selecting one or more customers, and requesting additional customer preferences corresponding to at least one of customer preference sets associated with at least one of the selected customers; receiving additional customer preferences in response to the requests and augmenting the customer preference sets corresponding to the requests with the received preferences; repeating the matching and determining steps based on the existing and augmented customer preference sets; and repeating the steps until the termination condition is met.

In accordance with some embodiments, the quality measure may be one of: expected total customer utility computed relative to some probability distribution over unknown willingness to pay (WTP) values for one or more of the at least two vendible items; an error bound on total customer utility computed relative to the unknown WTP values for the one or more vendible items.

In accordance with some embodiments, the termination condition may be one of: the quality measure of the matching exceeds some quality threshold; a maximum time limit for determining a matching is reached or exceeded; a maximum amount of additional customer preference set has been received.

In another aspect embodiments described herein may provide a system for matching customer preference sets associated with a customer group to vendible items, the system comprising one or more processors and a memory coupled to the processors and configured to store instructions executable by the processors to configure a matching machine to receive a pricing schedule for each of at least two vendible items, wherein at least one of the pricing schedules comprises at least one nontrivial pricing condition for the respective vendible item, and, for each pricing condition, a corresponding price for the respective vendible item; receive at least two customer preference sets from a customer group comprising at least one customer, wherein each customer preference set describes a customer preference for purchasing one or more units of at least one of the at least two vendible items; determine an objective function, wherein the objective function measures utility of the customer group when one or more received customer preference sets is matched to zero or more units of zero or more vendible items of the at least two vendible items, wherein the objective function measures the utility based on the customer preference sets and the pricing schedules; configure a matching engine with the objective function; determine, using the objective function and the matching engine, an optimal matching of one or more customer preference sets to zero or more units of zero or more vendible item of the at least two vendible items, wherein the matching comprises, for each customer preference set that is matched to the one or more units of at least one vendible item, a price to be paid for the respective matched units, wherein the price is based on the pricing schedule for the respective matched at least one vendible item; storing the matching in the memory and making the matching electronically available.

In accordance with some embodiments, each customer preference set may correspond to a customer of the customer group, wherein utility of a customer is a value the customer realizes from purchasing the zero or more units matched to each customer preference set corresponding to that customer at the price to be paid for the respective matched units, wherein the utility of the customer group is based on the utility of the customers of the customer group.

In accordance with some embodiments, the objective function may comprise one or more constraints to preclude one or more matchings of customer preference sets to units of vendible items from being an optimal matching. The constraints may be selected from the group of constraints consisting of customer budgetary constraints, customer capacity constraints, vendible item capacity constraints, vendible item budgetary constraints.

In accordance with some embodiments, the objective function maximizes the utility of the customer group, wherein the utility of the customer group comprises a sum of utilities of all customers. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have myopic stability and may be individual surplus maximizing, where the maximization is subject to a constraint that no customer would achieve a higher utility if at least one of the customer preference sets corresponding to that customer were matched to one or more units of one or more vendible items, different than the zero or more units matched to that customer preference set, at the price to be paid for the respective matched units. In accordance with some embodiments, the maximization constraint is approximate such that the utility of a customer that would be attained by matching at least one of the customer preference sets corresponding to that customer to one or more units of one of more products, different than the zero or more units matched to that customer preference set, at the prices of the matching, is greater than the utility of the customer determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have Nash or triggered stability wherein the maximization is subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to the different items. In accordance with some embodiments, the maximization constraint is approximate such that the utility of a customer that would be attained if at least one of the customer preference sets corresponding to that customer were matched to one or more units of one or more vendible items, different than the zero or more units matched to that customer preference set, at the prices of the different vendible items that would be paid had that customer preference set been matched to said different items, is greater than the utility of the customer determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may have group stability the maximization is subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items. In accordance with some embodiments, the maximization constraint is approximate such that the utility that the group of two or more customers would individually or collectively achieve, if at least one customer preference set corresponding to each customer in the group were matched to one or more units of one or more vendible items, different than the zero or more units matched to said customer preference sets, at the prices of the different vendible items that would be paid had said customer preference set been matched to said different items, is greater than the individual or collective utility attained by the customers of the group determined by the matching by no more than a threshold. The objective function may comprise one or more constraints to preclude one or more matchings of customer preference sets to units of vendible items from being an optimal matching. In accordance with some embodiments, the maximization is an approximate maximization which permits the utility of the customer group to be less than a maximum achievable utility of the customer group by at most some threshold. In accordance with some embodiments, a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units. In accordance with some embodiments, the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

In accordance with some embodiments, the matching may match a customer to one or more units of any of the at least two vendible items if the matched vendible item maximizes, based on the objective function, the utility for the customer associated with the customer preference set, wherein the utility is the difference between the WTP for the matched vendible item and the price to be paid for the matched vendible item.

In accordance with some embodiments, the objective function maximizes the utility of the customer group, wherein the utility of the customer group is based on utilities of customers of the customer group. The maximization may be an approximate maximization which permits the utility for the customer associated with the customer preference set matched to the vendible item to be less than that of some other vendible item by at most some threshold.

In accordance with some embodiments, a customer's utility may be the difference between a willingness to pay (WTP) for the matched vendible item and the price to be paid for the matched vendible item of the matching.

In accordance with some embodiments, the objective function maximizes a difference between a total utility of all customers and a total price to be paid for all matched vendible items. The maximization may be an approximate maximization which permits the difference to be less than another by at most some threshold.

In accordance with some embodiments, the method may further comprise outputting a contract or payment terms or vouchers for purchase between any customer associated with a customer preference set matched to any vendible item and a vendor offering for sale the matched vendible item, wherein said contract or payment terms or vouchers for purchase are based on the prices of the matching.

In accordance with some embodiments, the method may further comprise receiving payment from any customer associated with a customer preference set matched to one or more units of any vendible item and a vendor offering for sale the matched item, wherein said payments are based on the prices of the matching; issuing vouchers for purchase for purchase to the customers for any matched vendible item for which payment is received; and making payment to the vendor of the matched vendible item, wherein said payments are based on the prices of the matching and the received payments.

In accordance with some embodiments, at least one customer preference set may comprise a ranking of deals and the matching may match the customer preference set to one or more units of any of the at least two vendible items only if the match, given the price to be paid for the one or more units of any of the at least two vendible items, comprises a deal that is preferred to any other available deal, where an available deal consists of a second vendible item different from the matched item, and the price to be paid for said second vendible item.

In accordance with some embodiments, at least one customer preference set may comprise a partial customer preference set, wherein said partial customer preference set indicates constraints on the possible WTP values for one or more of the at least two vendible items.

In accordance with some embodiments, the matching may be further based on selecting, for each customer preference set providing partial customer preference set, a WTP value for each vendible item of the customer preference set, the WTP value selected to be consistent with the partial customer preference set.

In accordance with some embodiments, the matching is stable in that no customer would prefer to buy a different vendible item than the vendible item to which the respective customer is matched to in the matching. In accordance with some embodiments, the stability is an approximate stability.

In accordance with some embodiments, the prices may be personalized to the customer preference set matched to the corresponding vendible items. The personalized prices may minimize the total of all subsidies and contributions applied, subject to a constraint that each utility is maximized. In accordance with some embodiments, the personalized prices may minimize the size of a largest subsidy or contribution applied, subject to a constraint that each utility is maximized.

In accordance with some embodiments, the matching matches a customer preference set to one or more units of any of the vendible items only if the match maximizes the utility of the customer associated with the matched customer preference set, where the utility may be the difference between the WTP for the matched vendible item and the price to be paid for the matched vendible item of the matching.

In accordance with some embodiments, the matching may maximize the sum of the utilities for all customers associated with matched customer preference sets, where the utility of a customer associated with the matched customer preference set may be the difference between the WTP for the matched vendible item and the price to be paid for the vendible item. In accordance with some embodiments, the matching approximately maximizes the sum of the customer utilities, where customer utility for any of the at least two vendible items to which the customer is matched is the difference between said customer's WTP for the matched item and the price to be paid for the item; and where approximate maximization permits a matching whose sum of customer utilities is no more than some threshold less than that of any other matching. The matching may be subject to the constraint that, if the matching matches a customer preference set to one or more units of any of the at least two vendible items then the match maximizes the utility of the customer associated with the matched customer preference set.

In accordance with some embodiments, the pricing conditions comprise volume conditions indicating that the corresponding discounted price will be offered if the matching matches a customer preference set to at least the number of units of the vendible item indicated by the volume condition. In accordance with some embodiments, the prices comprise discounted prices which comprise absolute prices to be offered if the matching matches customer preference sets to at least the number of units indicated in the corresponding volume pricing condition for the respective vendible item.

In accordance with some embodiments, the prices comprise discounted prices comprise percentage or fractional discounts, where said percentage or fractional discounts are applied to a base price of the respective vendible item if the matching matches customer preference sets to at least the number of units indicated in the corresponding volume pricing condition for the respective vendible item.

Other aspects and features will become apparent, to those ordinarily skilled in the art, upon review of the following description of some exemplary embodiments.

### DRAWINGS

The drawings included herewith are for illustrating various examples of articles, methods, and apparatuses of the present specification and are not intended to limit the scope of what is taught in any way. In the drawings:

FIG. 1 illustrates a system for matching customers to vendible items (e.g., products, services, or resources) in accordance with embodiments described herein;

FIG. 2 illustrates a method for matching customers to vendible items in accordance with embodiments described herein;

FIG. 3 illustrates an example pricing schedule in accordance with embodiments described herein;

FIG. 4 illustrates example customer preference sets and pricing schedules in accordance with embodiments described herein; and

FIG. 5 illustrates a method for matching customers to vendible items in accordance with embodiments described herein.

While the above description provides examples of one or more apparatus, methods, or systems, it will be appreciated that other apparatus, methods, or systems may be within the scope of the present description as interpreted by one of skill in the art.

### DESCRIPTION OF VARIOUS EMBODIMENTS

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Consumers, businesses, or other individuals or organizations (hereafter customers) searching for desired products, services, resources and so on (hereafter referred to as vendible items) may be confronted with a choice of sellers or vendors offering items of greater or lesser desirability. Customers may be faced with a trade-off between the overall desirability of a specific item offered by some vendor and the price. Desirability of a specific item to a customer can depend on many factors, including: specific item attributes (e.g., how well does it fit the customer's needs), item quality, contract terms (delivery schedule, payment terms, return policy), vendor reliability, and so on. These factors may be aggregated by the customer to determine an overall level of preference. For example, the customer preference may be a willingness-to pay (WTP), for a desired item. The customer may trade-off her preferences (such as for example, a willingness-to-pay) for the items under consideration against their prices (possibly factoring in budget constraints) to determine the “best” item for her needs. In more concrete terms, a customer may choose the item that maximizes her individual surplus, or utility. In some example, utility may be the difference between her WTP and the price of that item. As will be described herein, other forms of customer preferences different from WTP may be specified by a customer and employed in embodiments described herein.

To illustrate, suppose a customer is considering the offerings from a specific item category (e.g., a spa treatment) from three different vendors (e.g., spa A, spa B, and spa C). Ignoring price, the customer may prefer A to B, and B to C. For instance, it may be that the treatment offered by A provides a greater variety of services she likes than either B or C; and while B and C are similar in terms of services, B may be closer to her home. A customer may have a variety of different reasons for preferring one vendible item (e.g., spa treatment) over another. Thus, if the prices for the three spas were equal, she would choose A. However, if A is more expensive than either B or C, whether or not she chooses A depends on how much more expensive it is than B or C, and how much more desirable its services are. For instance, if spa A is “worth” $25 more than spa B and $35 more than spa C, then she will select spa A (budget permitting) if the price of spa A is less than $25 more than spa B and less than $35 more than the price of spa C.

These deliberations become much more complicated when vendors offer discounts for their items, or require specific pricing conditions to be met before a particular price is offered for a vendible item. Example discounts include volume-based discounts, but other example discounts may also be used. Volume discounts can take many forms, but at their most basic, a vendor will offer its item for a lower price if the number of units purchased exceeds a certain threshold. In some cases, a vendor may offer multiple discount levels, with the effective per-unit price decreasing with increasing purchase volumes. While certain individual customers (e.g., businesses) will sometimes demand sufficient quantities to meet pricing conditions, often most customers will not want to buy enough quantity to justify a discount. For example, spa A may offer a discount if a customer pre-purchases some number of treatments (e.g., 3 for the price of 2); but if a customer has no need for more than one treatment, this discount offer is of no value to her.

Demand aggregation is a process by which the demands of multiple consumers for a specific item offering are pooled, and a bulk purchase commitment is made by the pooled group of consumers. If the aggregated demand achieves a certain pricing condition, a vendor may then offer the item at the corresponding discounted price to all members of the group. The pricing conditions may be volume-based. As described herein, other forms of pricing conditions may be used.

Demand aggregation in the consumer space has become increasingly popular. Services offering “group discounts” or “daily deals” may solicit discount offers from vendors and publicize these offers to subscribers or through other forms of online advertising. If sufficiently many customers sign up for “the deal”—that is, if the number of customers agreeing to purchase the vendor's offering at the discounted price meets or exceeds the vendor-specified threshold by some time deadline—the customers each purchase the item of the discounted price. If not, the vendor discount is retracted. While often referred to as “daily deals,” the paradigm is of course much more general. To illustrate, spa A may offer a discounted price for treatments if at least 500 people purchase the offer before a specific deadline. In our example, suppose spa A is too expensive for the customer in question if no discount is available (e.g., perhaps it costs $60 more than spa B). If the discount offered is $50, then spa A becomes preferred to spa B: while it remains $10 more expensive than B, if the volume threshold is reached, it is “worth” $25 more to the customer at the available prices, and the customer would sign up to purchase the item at the discounted price.

Demand aggregation occurs in the corporate setting as well. For example, buying consortia in specific industries aggregate the demand of their member companies for specific items, and use the total purchase volume as leverage in negotiating prices from specific vendors. Companies may also specify their demand for certain item categories via a web service. Demand aggregation functionality may also be provided for single corporate entities. By tracking purchase orders across different units and divisions of the company, multiple purchase requests for the same or similar items may be aggregated into a single purchase. Apart from decreasing paperwork, deliveries, and other overheads, this aggregation allows the company to take greater advantage of (sometimes pre-negotiated) volume discounts from its suppliers.

Existing mechanisms for demand aggregation may not provide a facility for customers to express their preferences for different item offerings, for different vendors, for different item and price combinations, and so on. As noted herein, customers generally have distinct preferences for specific items. Daily deal providers may present offers from a single vendor in isolation. For example, the discount offer from spa A is presented to potential customers without any reference to the possibility of purchasing an alternative treatment from spa B or spa C. This may be generally true even if the demand aggregator has similar agreements with spas B and C. As a consequence, the discount offers presented to customers are “take it or leave it” offers: either a customer agrees to accept the discounted price offered by spa A (should the volume threshold be reached) or refuses the deal. If the deal is accepted, a commitment is made.

Consumers may be able to search through volume discount offers of multiple vendors, organized by item category. However, while services may be provided that assist consumers in the search for relevant daily or group deals, and may allow somewhat crude comparison of such deals, such searching functionality may not address the commitment problem facing customers, nor the take-it-or-leave-it nature of the offers. For example, suppose each of three spas A, B, and C offer deals and a customer is aware of all three deals. The willingness of a customer to purchase any of them may depend on their purchase price. But this purchase price, in turn, depends on whether or not the pricing conditions for these spas are met. As a result, the customer cannot be certain which offer, if any, she should accept. For example, if she receives the proposed discounted price for A, but not the proposed discount for B or C, she would happily accept A's offer. But if the proposed discount for B materializes—even if A's does as well—she would prefer B to A. If she signs up for the deals for both A and B, she risks obtaining two spa treatments even if she only wants one. But if she signs up for only one, she runs the risk that the discount issues only for the other, leaving her shut out of a preferred deal.

Similarly, in corporate demand aggregation, volume discounts are typically negotiated with each vendor separately. However, since companies will typically have different preferences for item offerings and vendors, how demand is aggregated should similarly be sensitive to such company preferences. In corporate settings, there is an even stronger tradition of tiered pricing, or multiple discount levels offered for different purchase volumes. This makes the decisions facing customers and demand aggregators regarding which vendors to negotiate with, and which prices/discounts to accept, even more difficult.

Accordingly, matching customers and items is a fundamental problem in economics and market design. Embodiments described herein may address the problem of cooperative group buying, where a group of customers coordinate their purchases to realize volume discounts, mitigate demand risk, or reduce inventory costs. As noted, group buying may be used for corporate sourcing and procurement, via industry-specific buying consortia or broadly based group purchasing organizations (GPOs). The advent of the Internet, in particular, has helped businesses with no prior affiliation more easily aggregate their demand. Group buying may also be suitable for a single company or organization when, for example, multiple employees, units or divisions within the company each manage their own purchasing of certain vendible items. Consumer-oriented group purchasing may also be facilitated by the web.

Embodiments described herein may consider the fact that customers may have distinct preferences for the item offerings of different vendors. Known matching models with volume discounts may assume that item offerings are indistinguishable to customers, which may limit their applicability. For instance, suppose two customers X and Y are (jointly) comparing the item offers of two vendors for some item: vendor A offers a price of 10 for one unit, but a discounted price of 8 if both customers buy from him; and vendor B offers a single price of 9 per unit. If A and B are indistinguishable, X and Y should cooperate and buy from A. But suppose X prefers B (with valuation 11.5) to A (valuation 10). In this case, X would prefer to stick with B unless Y offers some payment to switch vendors (Y may share some of her generated surplus with X for this purpose). Without the ability to express preferences over vendors, “group buying” may not emerge even in this trivial example. Assigning customers to vendors in a way that triggers volume (or other forms of) discounts, while remaining sensitive to customer preferences, may offer flexibility and efficiency gains that greatly enhance the appeal of group buying. Consider a group of businesses or customers working with a GPO to procure supplies within a specific item category (e.g., manufacturing materials, packaging, transportation, payroll services, etc.). The GPO may be able to negotiate volume discounts from a handful of suppliers or vendors, possibly with multiple pricing conditions. Customers generally have different valuations for the offerings of different vendors (e.g., customers may have slightly different manufacturing specifications; or may prefer the contract, payment or delivery terms of certain vendors). A suitable matching of customers to vendors must trade off these preferences with the triggered discount prices.

The same issues may arise in consumer domains. Suppose a daily deal aggregator creates a “marketplace” for some item category, for example spa treatments. Multiple spas may offer deals that only trigger if a certain quantity is sold. Customers may be faced with a dilemma: they may want only one item, but may be uncertain about which deal will trigger. If they only offer to buy (i.e., conditionally purchase) their most preferred spa, they may not get any deal if their preferred deal does not trigger. But if they offer on multiple spas to hedge that risk, they run the opposite risk of obtaining more items than they want.

A matching model that allows consumers to specify preferences for items relative to other items, including items at their discounted price, may provide flexibility that benefits both consumers and retailers.

Embodiments described herein may allow customers of a customer group to express their preferences for different items and/or vendors using one or more customer preference sets, and assign (or “match”) the provided customer preference sets or customers associated therewith to the specific items or vendors. One customer may provide one or more customer preference sets. This matching may occur once the customer preference sets have been received. This assignment or matching may also take place prior to the preferences of all customers being received as long as two or more customer preference sets are received. The embodiments described herein may make this assignment in a way that optimally trades off the preferences of individual customers with the prices of the assigned items so that each customer receives her most preferred item at the discounted prices achieved by the matching. The present invention provides a method for eliciting preferences of customers and making such an optimal assignment. Still other objects of the present invention will become apparent to those of ordinary skill in the art upon reading and understanding the following detailed description.

A set of one or more vendors may be offering vendible items (e.g., within a specific item category). Interacting with a group of customers—for example an informal buying group—or some service acting on their behalf—for example, a daily deal aggregator, a demand aggregator, a GPO, chamber of commerce, or an industrial buying consortium—vendors may offer (possibly multiple) discounts, such as volume discounts for example, that trigger if the group collectively buys in way that meets the pricing conditions, for example purchasing a certain quantity of a specific item from a vendor. These may be proposed or negotiated in advance, and may be fixed, posted prices. For ease of exposition, customers may be described as having unit demand, and treat items may be treated as partial substitutes. However, extensions to, for example, multi-unit demand and other settings described herein, will be apparent to those of ordinary skill in the art. Each customer may have valuations for each item and quasi-linear utility. Since vendor prices may be fixed, embodiments described herein may find an assignment of customers to items that maximizes the sum of customers' utilities given the discounts that trigger, while ensuring stability, or customer “satisfaction” with the resulting allocation at the triggered prices. Embodiments described herein may consider two main variants of this problem. In the transferable utility (TU) model, the gains due to demand aggregation may be transferred between customers to ensure cooperation. In the non-transferable utility (NTU) model, each customer pays the (triggered) price of her allocated item. Both models have a role to play in specific business and consumer applications.

Since vendor prices may be fixed given some demanded quantity, the embodiments described herein may induce a coalitional game among the customers, which we refer to as a discount matching game. Vendor discounts may introduce significant externalities in the corresponding matching problem: this leads to the emptiness of core of such games in certain instances, both in the TU and the NTU sense. Embodiments described herein may consider unilateral deviations from the matching, and focus on the weaker notion of Nash stability under several different epistemic assumptions about the knowledge available to customers and their incentive to deviate from the matching produced by embodiments described herein.

Embodiments described herein may be used for TU games. In accordance with embodiments described herein, stable matchings (under all epistemic assumptions) may exist and maximize the sum of all customer utilities. Moreover, they can be realized using transfers only between customers that are matched to the same vendor. Embodiments described herein may consider computation of a matching that maximizes the sum of customer utilities: the corresponding decision problem may be NP-complete or computationally intractable, but, given a (fixed) set of discount prices, computing an optimal matching may be done in polynomial time. As a result, a mixed integer programming (MIP) model of the problem may be formulated in which binary matching variables can be relaxed, leaving a MIP whose only integer variables represent the triggering of specific pricing conditions. Standard off-the-shelf optimization packages (such as IBM's CPLEX) can be used to solve the MIP model described herein, but other algorithms may also be used to compute an optimal matching.

Embodiments described herein may also be used for NTU discount matching games, and stable matchings may exist. Embodiments described herein may be used for qualitative discount matching games, a variant in which customers do not specify valuations for items, but simply rank the deals offered (where a deal is any item and a price for the item, which may be one of its discounted prices). Embodiments described herein may be used for in consumer domains, where customers may be unable to articulate precise valuations or WTP values for items, but can easily compare any two items at specific prices. As long as the rankings are rationalizable (i.e., correspond to quasi-linear preferences under some latent valuation), again stable matchings may exist.

Embodiments described herein may provide benefits of preference based offers, automated matching, and volume discounts to groups of consumers, industrial buying consortia, and other formal or informal buying groups, in a way that is sensitive to the preferences of group members for different items or services, and the vendors offering those items or services. Embodiments described herein may provide greater incentive for vendors to offer discounts to such buying groups since vendors need not compete with one another solely based on price: instead attributes (including brand preference) that distinguish their offerings from those of their competitors can be reflected in the preferences expressed by consumers as customer preference sets. As a consequence, both customers and vendors may benefit from embodiments described herein.

By way of example, embodiments described herein may be illustrated through application to matching consumers to relevant volume-based discount offers from multiple vendors within an item category. By way of further example, embodiments described herein may also be illustrated for the case in which customers purchase one or more distinct items within an item category, and one or more units of any item so purchased. Examples described herein should not be construed as limiting the described embodiments, as the described embodiments may be applied to the matching and selling of multiple, diverse items and services from one or more vendors; to the matching of customers to more than one distinct item; to matching customers who desire multiple units of one or more vendible items; to the matching of customers to vendible items subject to customer budget or capacity constraints on the number of items or total payment they must make for the items to which they are matched; to the matching of customers to vendible items subject to vendor purchase volume or capacity constraints on the number of items or total payment they must receive for the items they provide (e.g. vendible item based constraints), and so on.

Accordingly, embodiments described herein may provide a computer implemented method and system of providing a matching of customer preference sets or customers to vendible items. Vendible items may be any product, service, resource, and so on. Vendible items may have multiple components and sub-components. Vendible items may be offered from the same vendor or different vendors. For example, one vendor may offer a product, such as a laptop computer, at two different locations, where each may be viewed as a different vendible item. A vendible item may be an item bundled with contract terms, which may also be viewed as attributes of the item. Contract terms may include payment details, delivery details, warranty, vendor, and so on, which can be made available for purchase. For example, one manufacturer may make widget A and two different vendors may be resellers of the widget A. Each vendor may offer the same widget A on different contract terms. Vendor A may offer widget A requiring upfront payment of a price, while Vendor B may offer widget A with a 30-day payment period for a different price. In this example, widget A with upfront payment may be one vendible item and widget A with 30-day payment may be another vendible item. Accordingly, the same widget A may be part of two different vendible items distinguished based on contract terms or other attributes. Other example vendible items are provided herein.

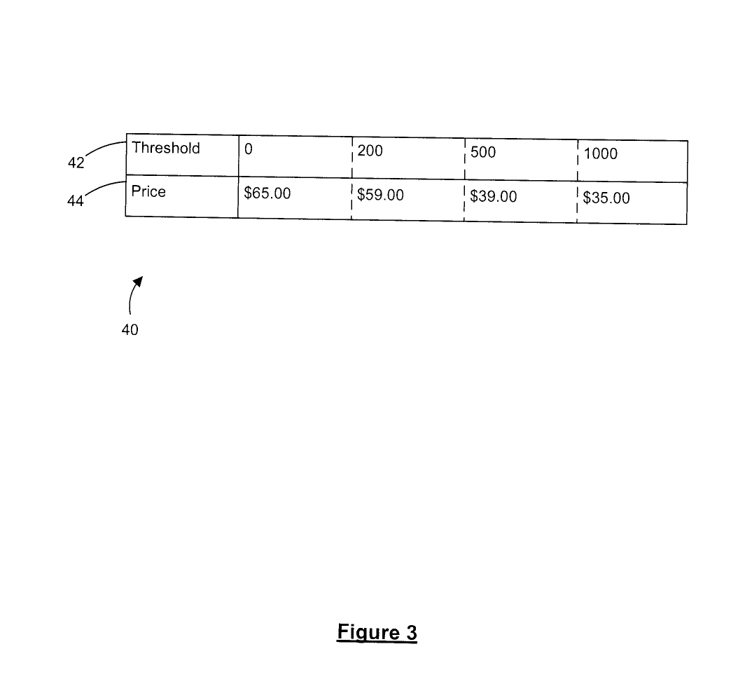

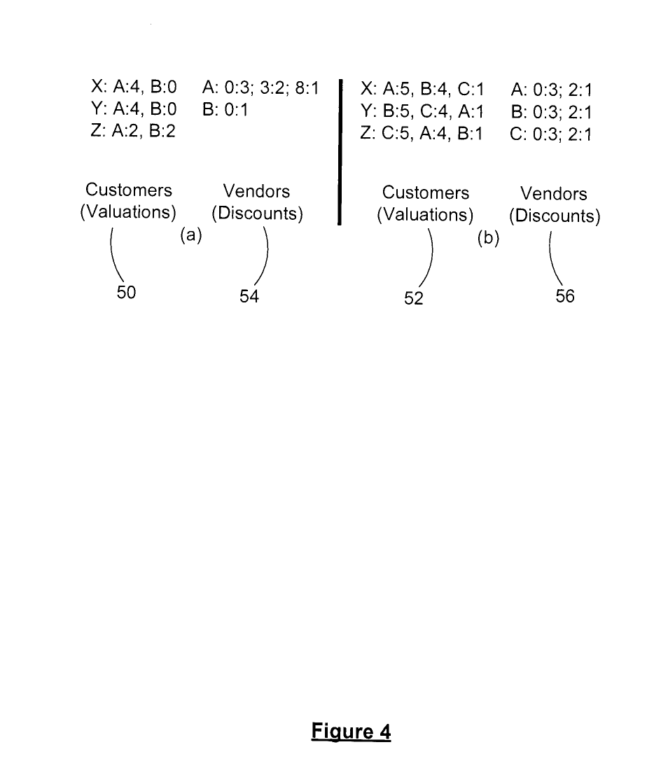

A pricing schedule may be received for each of at least two vendible items. The vendible items may be associated with one or more vendors. Each pricing schedule may include pricing conditions for the corresponding vendible item. Each pricing schedule may also include, for each pricing condition, a corresponding price for the respective vendible item. Formally, by way of example only, a pricing schedule may be two vectors, one vector of pricing conditions and another vector of prices if the corresponding pricing condition is met or is triggered. A pricing schedule may also be a function that receives a value corresponding to a condition (e.g. a number of units to be bought) which may output the price to be paid based on the provided value. Other forms may also be used for the pricing schedule. An example pricing schedule is shown in FIGS. 3 and 4, as will be discussed herein. A pricing condition triggers what price the item may be sold for. That is, if the pricing condition is met then the vendible item may be sold for the corresponding price. As one example, pricing conditions may be volume based and triggered when a particular number of units are sold, or are agreed to be sold. The price per unit may decrease as the number of units to be sold increases. The pricing conditions may relate to a particular item, all items to be sold by a particular vendor, all items purchased by a particular customer, customer attributes, and so on. A pricing condition may also relate to market share of a vendible item. Further, a pricing condition may be associated with the types of customers to purchase the item. For example, the pricing condition may be associated with attributes of one or customers matched to that item, such as revenue, age, size, gender, net worth, and so on. By way of example, a vendor may be willing to sell items to a company with large revenue at a lower price in order to increase the odds of future sales to that company. As another example, a vendor may offer a higher discount if at least three customers matched to an item are highly connected in a particular social network, with the aim of increasing word-of-mouth “buzz” around their brand of product. As another example, the pricing conditions may be specified as a ratio or bundle of different items. For example, a vendor may offer a discount if at least five pounds of chemical X is purchased with at least three pounds of chemical Y; for example, chemical Y may be a byproduct of the process by which chemical X is produced, which may make the production of chemical Y cheaper. The prices corresponding to pricing conditions may include a base price and discount prices. The prices may be absolute or may be expressed as a fraction or percentage of a base price. At least one pricing schedule for a vendible item will have at least one nontrivial pricing condition. A nontrivial pricing condition may be a condition that is not always triggered, met or satisfied, and is not always true or false. A nontrivial pricing condition is not a null condition. For example, a nontrivial pricing condition may be “at least ten items must be purchased”, which is not always met such as when only nine items are purchased. As another example, a nontrivial pricing condition may be “customer is at least 60 years old”, which is not always met such as when a 30 year old customer offers to purchase the item. Some pricing conditions may be associated with a base price, or non-discounted price, for the item. Pricing conditions associated with the base price may always be true. The base price may be the price if only one unit is sold, or another case where the associated pricing condition is always triggered. Multiple pricing conditions may be met which may trigger multiple prices. In such case, the lowest triggered price may be selected. Other example pricing schedules, pricing conditions and prices are provided herein.

At least two customer preference sets may be received from at least one customer. A customer preference set describes preferences of a customer for one or more of the items offered for sale. That is, a customer preference set may describe a preference to purchase at least one vendible item over at least one other vendible item, or a preference to purchase at least one vendible item at a particular price over at least one other vendible item at a particular price. A customer preference set may include a willingness to pay (WTP) value for one or more of the offered items. A customer preference set may also rank, or partially rank, one or more of the offered items relative to other offered items. The customer preference set may also rank a deal over other deals, where a deal is a combination of an item and a price for the item. The customer preference set may explicitly allow customers to express preference over different item offerings. As an example, a customer preference set may be provided in the form of a valuation function which receives an item and returns a value associated with the item. A customer preference set may also be provided as a vector of values (such as WTP values) for corresponding items. An example is shown in FIG. 4 as will be described herein. A customer preference set may include a rating or scoring of items. A rating may be, for example, on a prespecified scale (such as 1 to 5), or using “likes” and “dislikes”. A customer preference set may include a ranking of items (for example, from most-to-least preferred or least-to-most preferred, or for example allowing ties in the ranking). A ranking may be relative to other offered items. A customer preference set may include a ranking of “deals” where a deal refers to a specific vendible item offered at a specific price. It may also be a partial customer preference set that does not include each item offered or every price offered for every item.

Each customer preference set is associated with a customer. More than one customer preference set may be received from, or associated with, the same customer, or they may be from different customers. For example, a customer may be a head office operating two different factories that require vendible items (e.g., raw materials or packaging for their products). Each factory may have a different customer preference set for vendible items even though each different customer preference set is associated with the same customer, namely, the head office. As another example, one customer may provide a customer preference set and another customer may provide a different customer preference set. Further, partial preferences may also be provided and certain embodiments described herein may request additional preferences from one or more customers, or allow customers to provide additional preferences. Other example customer preference sets are provided herein.

An objective function measures utility of a customer group when zero or more customer preference sets associated with the customer group are matched to one or more units of at least one vendible item of the at least two vendible items. The objective function measures the utility based on the customer preference sets and the pricing schedules. The utility of a customer may be a value the customer realizes from purchasing the zero or more units matched to each customer preference set corresponding to that customer at the price to be paid for the respective matched units. The utility of the customer group is based on the utility of the customers of the customer group. That is, utility of a customer provides a measure of customer satisfaction with the zero or more units of the zero or more vendible items to which that customer is assigned. For example, a customer's utility for a unit of an item may be that customer's WTP value for that item less the price to be paid. As another example, a customer's utility for receiving a certain item and a certain price may be defined as a function of the rank position of that “deal” (or item-price) pair in that customer's customer preference set. As still another example, a customer's utility may be defined in a binary fashion, indicating satisfaction if the deal received by that customer in the matching is among his most preferred deals among those available at the prices triggered by the achieved pricing conditions over all items.

The objective function may include one or more constraints to preclude one or more matchings of customer preference sets to units of vendible items from being an optimal matching. Example constraints include customer budgetary constraints (e.g. customer has only forty dollars to spend), customer capacity constraints (e.g. customer can only purchase a maximum of four items), vendible item capacity constraints (e.g. vendor can only sell twenty of item A), vendible item budgetary constraints (e.g. vendor can only sell if at least four hundred dollars of items sold), as described herein.

A variety of objective functions may be used and various example objective functions are provided herein. The objective function may be used to provide a measure of the quality of the matching and may be optimized (which may also refer to near-optimization or approximate optimization) to determine an optimal matching. For example, the objective function may maximize the utility of the customer group, where the utility of the customer group comprises a sum of utilities of all customers. The maximization may be an approximate maximization which permits the utility of the customer group to be less than a maximum utility of the customer group by at most some threshold. In some examples, each customer may be assigned a weight factor, and the utility of the customer group may be a weighted sum of utilities of all customers of the customer group. For example, an important customer may be assigned a higher weight. The optimal matching may be stable by subjecting the optimization to a constraint. For example, the maximization may be subject to a constraint that no customer would achieve a higher utility if matched to vendible items, at the prices determined by the matching, different than items matched to each customer preference set corresponding to that customer at the price to be paid for the respective matched units. The maximization may also be subject to a constraint that no customer would achieve higher utility if matched to vendible items different than the matched items corresponding to that customer, at prices of the different vendible items that would be paid had the customer been matched to said different items. The maximization may also be subject to a constraint that no group of one or more customers would individually or jointly achieve higher utility if matched to items different than the items matched to that customer, at a prices of the different items that would be paid had the group of one or more customers been matched to the different vendible items. These maximization constraints may be approximate.

As another example, the objective function may minimize (or may approximately minimize) a sum of the prices to be paid for the vendible items of the matching. As further example, the objective function may maximize (or may approximately maximize) the utility for each customer individually, where a customer may be matched to a vendible item that provides a greater utility than any other vendible item given the prices of the matching. As another example, the objective function may maximize (or may approximately maximize) a sum of utilities of all customers, or it may maximize (or may approximately maximize) a weighted sum of utilities of all customers, where each customer is assigned a potentially different weight. As another example, the objective function may maximize (or may approximately maximize) a difference between a total utility of all customers and a total price to be paid for all matched vendible items. The objective function may also include one or more constraints, or may be optimized (or approximately optimized) subject to the satisfaction of one or more constraints, as described herein. A constraint may preclude a matching from being part of the optimal matching. For example, any of the objectives above (e.g., maximizing sum of customer utilities) may be subject to one or more of the following constraints: (a) a budget constraint for a customer which limits the total amount that to be paid by that customer for matched items; (b) a capacity constraint for a vendor or vendible item, which limits the total number of customers matched to, or items provided by, that vendor or vendible item; or (c) a stability constraint which ensures that a customer does not prefer to be matched to one or more units of a different vendible item than the one determined by the matching. Stability constraints are described in further detail herein. These constraints are illustrative examples only and not to be construed as limiting.

The utility may be a level of satisfaction, such as satisfaction with a payoff, price, stability of matching, transfers, and so on. The utility may relate to a customer (which in turn is associated with one or more customer preference sets). For example, utility of a customer may be a value the customer receives from purchasing a vendible item at a particular price. As another example, the utility of a customer may be the difference between the WTP value for a vendible item and a price to be paid for the vendible item.

The objective function is used to determine an optimal matching of zero or more customer preference sets to zero or more units of at least one vendible item of the at least two vendible items. The matching may include, for each customer preference set matched to the one or more units of the at least one vendible item, a price to be paid for the respective matched units, where the price is based on the pricing schedule for the matched vendible item. The matching may be an empty set if no customers can be matched to items in view of the pricing schedules, customer preference sets, objective function, and so on. In some cases, no customers may be matched to items (e.g. zero customer preference sets). In other cases, one or more customers may be matched to zero items (e.g. zero units). The matching may also match one or more customers and leave one or more customers unmatched (which may be interpreted as matching “unmatched” customers to zero items) in view of the pricing schedules, customer preference sets, objective function, and so on. The matching may include a price to be paid by for the one or more units of the vendible item(s). The price may be based on the pricing schedule for the respective vendible item, but may not be the same price listed in the pricing schedule and may instead be a personalized price, for example, and may be different from other prices to be paid by other customers for each unit of the vendible items in the matching. As described herein, the personalized prices may be computed based on subsidies and contributions transferred between customers. The optimal matching may be obtained based on an optimization of the objective function, a near-optimization, or an approximate optimization. For example, a matching may match a customer preference set to one or more units of any of the at least two vendible items if the matched vendible item maximizes, based on the objective function, the utility for the customer associated with the customer preference set. The matching may be a stable matching in that no customer would prefer to buy a different vendible item than the vendible item to which the respective customer is matched to in the optimal matching, or an approximately stable matching. Different embodiments may utilize various forms of stability and approximate stability, as described herein

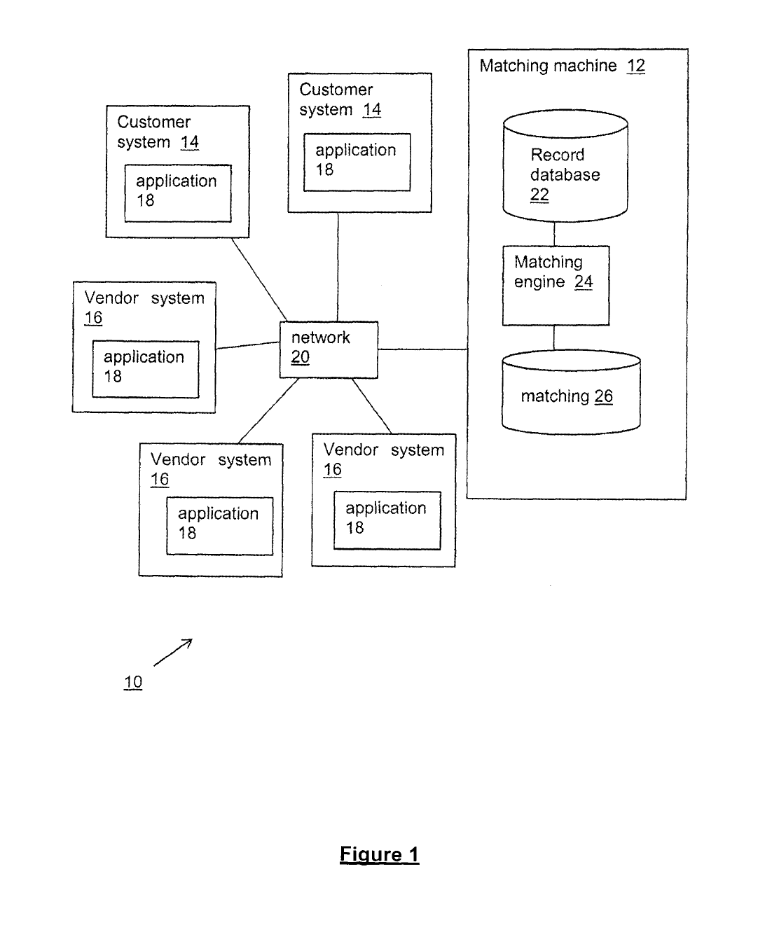

Referring now to FIG. 1, there is shown a system 10 for matching customers to vendible items (e.g. product, services, resources). System 10 may include a matching machine 12 connected to customer systems 14 and vendor systems 16 via a network 20. In accordance with some embodiments, customers systems 14 and vendors systems 16 may connect with matching machine 12 via computing applications 18 residing thereon to access the functionality of matching machine 12.

Customer system 14 may be any networked computing device operated by a customer of system 10 including a processor and memory, such as an electronic tablet device, a personal computer, workstation, server, portable computer, mobile device, personal digital assistant, laptop, smart phone, WAP phone, an interactive television, video display terminals, gaming consoles, and portable electronic devices or a combination of these. A networked device is a device capable of communicating with other devices and components of system 10 and matching machine 12 through a communication network such as network 20. A network device may couple to the communication network through a wired or wireless connection. Similarly, vendor system 16 maybe any networked computing device operated by a vendor offering a vendible item (e.g. service, good, resource) and may include a processor and memory. Although only two customer systems 14 are shown there may be more customer systems 14 connected to network 20. Similarly, although only three vendor systems 16 are shown there may be more vendor systems 16 connects to network 20.

Application 18 may include software modules comprising computer executable instructions to configure customer system 14 and vendor system 16 to provide input data to matching machine 12 (e.g. customer preference sets, pricing schedules) and to receive output data from matching machine 12, such as a matching 26, or item and price allocated to a particular customer or from a vendor. Application 18 may be any software application, application plug-in (e.g. a widget), instant messaging application, mobile device application, e-mail application, online telephony application, java application, web page, or web object (e.g. a widget) residing or rendered on customer system 14 or vendor system 16. Application 18 for customer system 14 may be specialized or customized for such customer system 14. Similarly, a different application 18 for vendor system 16 may be specialized or customized for such vendor system 16.

Network 20 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these. There may be multiple network(s) 20 linked to connect components of system 10.

Matching machine 12 may include a hardware network interface for connecting to a network 20 such as wired or wireless connection to the Internet or other type of computer or telecommunication networks, which may correspond with the network(s) 20. Matching machine 12 may also include a memory, a secondary storage device, a processor, an input device, a display device, and an output device. Memory may include random access memory (RAM) or similar types of memory, and it may store one or more applications for execution by processor. Secondary storage device may include a hard disk drive, floppy disk drive, CD drive, DVD drive, Blu-ray drive, or other types of non-volatile data storage. Processor may execute applications, computer readable instructions or programs stored in memory or secondary storage, or received from the Internet or other network 20. Input device may include any device for entering information into matching machine 12, such as a keyboard, key pad, cursor-control device, touch-screen, camera, or microphone. Display device may include any type of device for presenting visual information such as, for example, a computer monitor, flat-screen display, projector or display panel. Output device may include any type of device for presenting a hard copy of information, such as a printer, and may also include other types of output devices such as speakers, for example. In some cases, server 1 may include multiple processors, applications, software modules, second storage devices, network connections, input devices, output devices, and display devices.

Although matching machine 12 is depicted with various components, matching machine 12 may contain additional or different components. In addition, although aspects of an implementation consistent with various embodiments are described as being stored in memory, one skilled in the art will appreciate that these aspects can also be stored on or read from other types of computer program products or computer-readable media, such as secondary storage devices, including hard disks, floppy disks, or CDs, DVDs; a carrier wave from the Internet or other network; or other forms of RAM or ROM. The computer-readable media may include instructions for controlling matching machine 12 and/or processor to perform a particular method, or particular steps of a method.

Matching machine 12 may be a server system that has one or more processors with computing processing abilities and memory such as a database(s) or file system(s). Although only one matching machine 12 is shown for clarity, there may be multiple matching machines 12 distributed over a wide geographic area and connected via e.g. network 20. Matching machine 12 may be any suitable electronic computing device. For example, the matching machine 12 may be a server, computing device with a processor and memory, desktop computer, notebook computer, server computer, mobile phone, PDA, specialized hardware, or any other electronic computing device. Alternatively, the system 10 may include a plurality of devices which collectively form the matching machine 12. For example, the system 10 may include two or more computers, laptops, PDAs, servers and mobile devices each of which perform the same or different functions separately or cooperatively.

Matching machine 12 may include a matching engine 24 configured with particular objective functions to generate an optimal matching 26 which links customers (or the associated customer preference sets) to items, and further specifies a corresponding price for the matched items. Matching machine 12 may also include a record database 22 for storing records regarding customers, vendors, items, pricing and so on. Matching machine 12 may be configured to compute an optimal matching that is stable or approximately stable. Matching machine 12 may use matching engine 24 to compute an optimal matching that is near-optimal or approximately optimal. Matching machine 12 may further configure the objective function with constraints, as described herein.

Accordingly, embodiments described herein may provide a computer network implemented matching machine 12 and corresponding method that, based on at least two item offerings and the logging of customer preference sets regarding at vendible item (i.e. product, service) and associated with at least one potential customer or buyer (the “customer group”), where the one or more customers collectively provide at least two customer preference sets, enables the calculation of a matching between the item offerings of the vendors and the members of the customer group that includes the assignment of each customer preference set to one or more units of zero or more item offerings such that matching of the collective matched offerings to the customer group members may be optimized (e.g., optimization, approximation, or near optimization) across the customer group in a way that maximizes the realization of the respective preferences of the various members of the customer group, in connection with an open customer event. It should be understood that “preferences” is used in a broad sense so as to reflect not only price preferences of group members, but also preferences relevant to other reasons for selecting one offering or another, such as brand preference, location, contract terms, payment terms, item specifications, item attributes and so on.

The pricing schedules may outline discount offerings, by specifying a pricing condition and a corresponding price if the pricing condition is triggered. The pricing conditions may include volume thresholds, as explained herein, such that the benefits associated with increased sales volume, offered by the vendors, may increase based on predetermined thresholds. One of the implications of the present technology is that, for example, Customer A, based on an associated customer preference set, may be equally interested in Item X and Item Y. However, the matching machine 12 is operable to allocate Customer A to Item X if this enables the optimization of the realization of the respective preferences of Customer A and other Customers B, C, D, . . . n in the customer group. For example, the allocation of Customer A to Item X may trigger the availability of other offerings that may be consistent with the optimization relative to the preferences of Customer B, C, D, . . . n. The present technology may enable a series of techniques that in a computationally efficient way enable the achievement of a better overall result for the customer group as a whole. This improves value of the item obtained by each customer, including based on preferences other than price alone, driving additional business to a web platform implementing the present technology (in some embodiments) including through repeat customers, and also enabling improved brand engagement between the customer and the matched vendor(s) through the improved value and “satisfaction” associated with the improved value. This in turn, may motivate vendors to improve the benefits that they provide through the platform, which further drives adoption, transactions, and positive brand engagement. From a general perspective, the platform represents a unique and innovative way to ensure that a greater number of customers obtain the item that they want, on terms that are close as possible to the terms that they desire.

The methods and systems 10 described herein may be implemented for example in a variety of group customer/vendor matching web and/or mobile platforms, or as a web-implemented engine that provides suggested vendor/customer allocations as a web service to one or more linked platforms. The methods and systems 10 described herein may also be implemented for example within the purchasing, sourcing, procurement, or enterprise software systems of businesses, industry buying consortia, public enterprises, or other organizations, providing suggested vendor/customer assignments for members or divisions of these organizations.

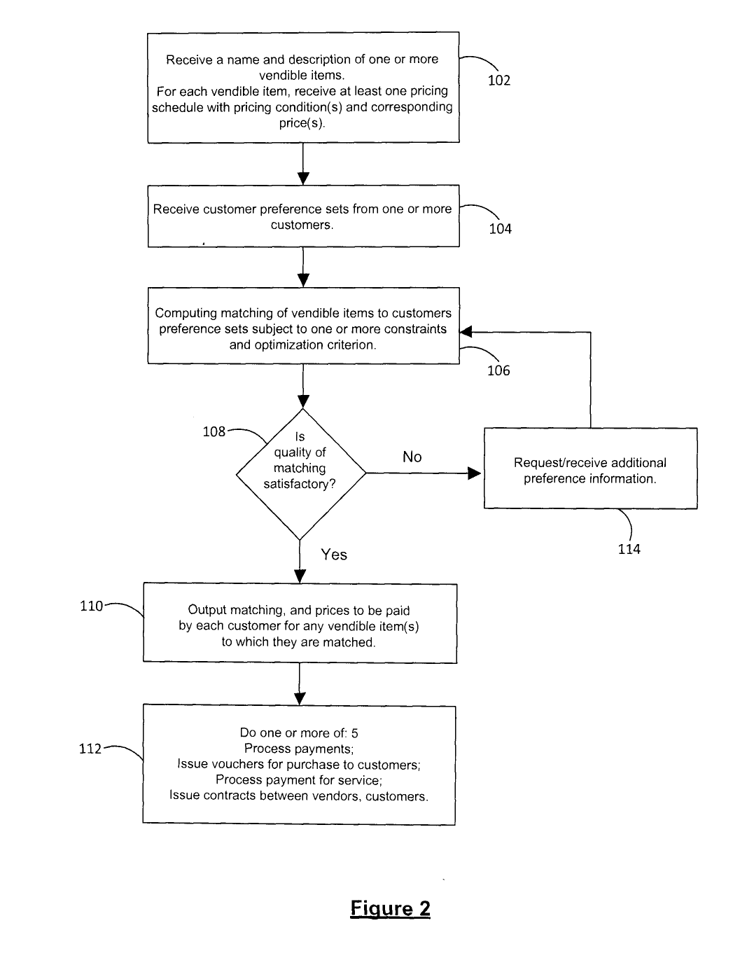

Referring now to FIG. 2 there is shown a method 100 for matching customers to vendible items in accordance with embodiments described herein. As an illustrative example, the basic workflow of the described embodiments may center on an event.

At 102, during the course of the event, a name or description of one of more vendible items (i.e. products, services or resources for sale) may be received. For each vendible item, a pricing schedule may also be received detailing pricing information for the item. This information may be submitted by one or more vendors associated with the vendible items. One vendor may be associated with one or multiple vendible items. Different vendors may be associated with the same or different vendible items, but the combination of a vendor and a vendible item may be treated as a different vendible item than the combination of a different vendor with the same vendible item. Different vendors may submit different pricing schedules for the same vendible item. The combination of a pricing schedule and a vendible item may be treated as a different vendible item than the combination of a different pricing schedule and the same vendible item. A pricing schedule may include one or more pricing conditions and a corresponding absolute or relative discounted price for each pricing condition. If the conditions of a pricing condition are met by matching the customer preference sets of the customer group to units of vendible items, the discounted price may be applied or used by the matching (i.e., the pricing condition “triggers,” making the corresponding price available to the customer group). Referring now to FIG. 3 there is shown an example pricing schedule 40. In this example, the pricing schedule 40 includes four pricing conditions 42 and a corresponding price 44 for each pricing condition. For this example, the pricing conditions are volume based, and in particular, are triggered when 0, 200, 500, 1000 units are sold. The volume based pricing conditions may relate to a particular item, all items to be sold by a particular vendor, and so on. The pricing condition 42 of 0 has a corresponding price 44 of $65.00, which also may be referred to as a base price. The pricing condition 42 of 200 has a corresponding price 44 of $59.00 (i.e. when at least 200 units are sold each unit is priced at $59.00). The pricing condition 42 of 500 has a corresponding price 44 of $39.00, and the pricing condition 42 of 1000 has a corresponding price 44 of $35.00. Accordingly, the example pricing schedule 40 illustrates an example of volume-based discounts because the price per unit decreases when the number of units to be sold increases. Matching machine 12 is operable to store the received pricing schedules in record database 22. A pricing schedule may include a base price, which may be a non-discounted price with an associated pricing condition that is always met.

At 104, customer preference sets concerning customer preferences for one or more of the vendible items listed for sale are received from a customer group, directly from the customers, from customer agents, or from some data source(s) which tracks, store or estimates the preferences of customers. The customer group may include one or more customers. One customer may provide multiple customer preference sets in some examples. In accordance with some embodiments, a customer preference set may include a willingness to pay for one or more of the offered vendible items. A customer preference set may also rank, rate or score one or more of the vendible items relative to other vendible items offered. A customer preference set may also rank one or more of the offered vendible items at specific values relative to other offered vendible items at specific prices. That is, the customer preference set may explicitly allow customers to express preference over different vendible item offerings or different vendible items at specific prices. As another example, a customer preference set may be provided in the form of a valuation function for each customer. Matching machine 12 is operable to store the received customer preference sets in record database 22.

Referring now to FIG. 4 there is shown customer preference sets 50, 52 and pricing schedules 54, 56 that may be received at 102 and 104. Customers X, Y, Z are shown to provide customer preference sets 50, 52 for specific vendors A, B, C. For this example, each vendor is assumed to be associated with a single, distinct vendible item. The customer preference sets 50, 52 may be specified in the form S:v (the preference value v for vendor S). The preference value v may be the customer's willingness to pay for a vendible item offered by vendor S. For this example, one customer preference set 50 specifies that customer X's preference set is A:4, B:0 and customer Y's preference set is A:4, B:0 and customer Z's customer preference set is A:2, B:2. Pricing schedules may also be specified in the form q:p (where the pricing condition is to sell quantity q and associated unit price p). For this example, one set of pricing schedules 54 specifies that vendor A provides a pricing schedule of 0:3; 3:2; 8:1 and that vendor B provides a discount of 0:1.

Based on the received information, at 106, matching engine 24 is operable to determine an optimal matching of customers to items, with the aim of finding a matching that optimizes (i.e. optimization, approximation, or near-optimization) an objective (which may be represented by an objective function). That is, at 106, matching engine 24 is operable to match customer preference sets to one or more units of vendible items. Matching engine 24 is configured to determine the optimal matching using an objective function, examples of which are described herein. Further, the optimal matching may be stable, such as myopic stability, Nash stability and group stability, for example. The stability may be an approximation as described herein. Further, matching engine 24 may optimize the objective function to determine the optimal matching, such as by determine a maximum or minimum. As an example, said objective may involve maximizing the utility of customers by discovering which matching presents the greatest discount opportunities for the group of customers. The optimization may be a near optimization or an approximate optimization. Matching engine 24 is further configured to include one or more constraints in the objective function to preclude particular matchings from being part of the optimal matching. Matching machine 12 is operable to store the computed matching in record database 22.

At 110, system 10 is operable to output prices to be paid by each customer for any item to which a customer preference set associated with the customer is matched with. Accordingly, system 10 is operable to output the matching and the corresponding prices. Upon this output, at 112, system 10 may issue vouchers for items, process payments for items, and issue contracts between customers and vendors. Customers may be contractually required to purchase any matched items at the output prices, and vendors may be contractually required to sell their items to any matched customers at the output prices.

As will be described further herein, at 108 system 10 is operable to determine whether the quality of the matching is satisfactory prior to outputting the matching at 110. If it is determined that the quality of the matching is not satisfactory, then at 114, system 10 is operable to request/receive additional customer preferences from customers, or their agents, or from some data source(s) which tracks, store or estimates the preferences of customers, and return to 106 to re-compute a matching. Customer preference sets may be augmented with the new customer preferences.

In accordance with embodiments described herein, matching machine 12 is operable to match consumer preference sets to units of vendible items offered by vendors in a specific item category in the course of a specific event. Embodiments described herein can be used in multiple events in which the same or distinct consumers and vendors participate.

Vendors of items within the category may express interest in participating in an event. In accordance with embodiments described herein, selected vendors (hereafter vendors) may list one or more vendible items within the category that will be offered for sale in the current event, and may provide some additional description of said items. The additional description may include, but is not limited to, one or more of: textual descriptions, images, item specifications, contract or purchase terms and limitations, item reviews, and comparisons to competitor's items. In accordance with embodiments described herein, for each item, a vendor may specify an undiscounted price—the base price—for that item. The base price may be the price corresponding to a “null” or non-restrictive pricing condition, wherein the base price is available to any customer regardless of the number of types of other customers that are matched to or purchase that item. Alternatively, in the case where the discount schedule includes volume pricing conditions, the base price may be viewed as being triggered whenever a “trivial” volume threshold of 0 is reached. This corresponds to an undiscounted price for one or more units of that item. In alternate embodiments, the base price may be left unspecified, and may be set to a default level. This default level may be “infinite,” meaning that the items will not be sold unless specified volume thresholds are met. In still other embodiments, a vendor may specify a base price and leave the corresponding pricing condition unspecified, where a default “null” or non-restrictive pricing conditions is assumed for said base price in such as case.

In accordance with various embodiments described herein, for each item listed by a vendor, that vendor may also specify one of more distinct pricing conditions (such as volume thresholds for example) at which specific discounts will trigger. A pricing condition must be satisfied in order for the corresponding price to trigger. At least one pricing condition will be a nontrivial pricing condition that is not always satisfied, and not always true or false. Other types of pricing conditions or triggers may also be used, for example, the pricing condition may be associated with attributes of one or more customers associated with customer preference sets matched to that item, such as revenue, age, size, gender, net worth, and so on. In the case that volume thresholds may be used by one or more vendors, each volume threshold may be a positive real number specifying an absolute volume that must be achieved for the corresponding discount to trigger. For an item j with K distinct thresholds, these thresholds may be referred to as τ₁^{j}, τ₂^{j}, . . . , τ_{K}^{j}, where τ₀^{j}<τ₂^{j}< . . . <τ_{K}^{j}. By convention, certain embodiments may assume τ₀^{j}=0 for any item j. A pricing condition may also be associated with a base price, which may be a non-discounted price for the corresponding vendible item.

For each of the pricing condition specified by a vendor for one of its items, the vendor may also specify a price or discount for that item that triggers should that pricing condition be met or reached. The discounts may be specified as discounted prices. By way of example a pricing condition may be a volume threshold. For an item j with K distinct thresholds, the corresponding prices may be referred to as p₁^{j}, p₂^{j}, . . . , p_{K}^{j}, where p₀^{j} may denote a base price of item j, which can be viewed as the price corresponding to the volume threshold τ₀^{j}=0 for item j. Vendors may be required to specify discounted prices that decrease as the volume thresholds increase; so p₀^{j}>p₁^{j}>p₂^{j}> . . . >p_{K}^{j}. Vendors may also specify discounted prices using fractional or percentage discounts relative to a base price or some other reference price.

The interpretation of the volume thresholds and discounted prices may be as follows: if the number of units of item j sold during the current event meets or exceeds a specific threshold, say, τₜ^{j} but fails to meet or exceed the next threshold τₜ₊₁^{j}, then each unit of the item is sold for price pₜ^{j} corresponding to the maximally satisfied threshold.

Collectively, the pricing conditions, the base price (if any, or price corresponding to a pricing condition that is always satisfied), and the corresponding discounted prices for a vendible item specified by a vendor may be referred to as a pricing schedule. As noted above, an example pricing schedule 40 is illustrated in FIG. 3, where a vendor has specified for the item in question: a base price of $65; a discounted price of $59 if 200-499 units are sold; a discounted price of $39 if 500-999 units are sold; and a discounted price of $35 if 1000 or more units are sold. Other example pricing schedules 54, 56 are provided in FIG. 4.

Other embodiments described herein may allow vendors to specify pricing conditions as market share thresholds for specific items that reflect the overall share of the total number of units during the event. In particular, a vendor may specify a series of one or more fractional volume thresholds, where each threshold τₜ^{j} for an item j is a value between 0 and 1 (or a percentage between 0 and 100). The corresponding discount triggers if the fraction of the total item volume sold in the event accounted for by item j meets or exceeds τhd t^{j}.

Other embodiments described herein may allow a vendor to group two or more of its listed items, and provide pricing conditions based on the aggregate sale of all items in the group.

Still other embodiments of the invention allow discounts to be specified by a vendor using percentage discounts, where each percentage discount is applied to the base price of the item, or to some other reference price for the item.

In embodiments in which an infinite base price is specified or assumed for an item j, the matching of customers to items may ensure the sale of at least τ₁^{j} units of item j within the current event, or else sell zero units of j.

Customers interested in purchasing items within the category may express interest in participating in an event. Selected customers (hereafter customers) specify preferences for one or more of the items listed in the event. As described herein, various embodiments may allow a customer to submit one or more preference sets, and matchings may match zero or more customer preference sets to one or more units of at least one of the two or more vendible items. However, for ease of exposition of the following algorithmic embodiments, we will describe specific matching algorithms for the case in which each customer submits one customer preference set; and when describing a matching of a customer to one of more units of a vendible item, this may be construed equivalently as matching the (single) customer preference set associated with said customer to the same one of more units of the same vendible item. The illustrative examples may be extended to cases where one or more customers submits more than one preference set, by matching customer preference sets to one or more units of the vendible items rather than customers themselves. The utility of a customer may be considered based on the utility of all customer preference sets matched to items and associated with that customer.

In accordance with embodiments described herein, customers may specify their preference for each item in the form of a maximum value, or willingness-to-pay. The willingness-to-pay (WTP) value of customer i for item j may be denoted by vᵢⱼ. The net value or utility a customer receives from purchasing item j at price p may be represented as vᵢⱼ−p. That is, the utility may be the difference between the WTP value for an item and the price to be paid for the item. This may also represent customer i's individual surplus. In accordance with other embodiments described herein, customers may express full or partial preferences in a different fashion. For illustration, each customer may be assumed to be interested in the purchase of at most one unit of any item, though other embodiments allow customers to specify the number of units of the items they desire, or to specify a desire to purchase some one or more units of one or more distinct items.

### Matchings

The price paid by any customer for an item j may depend on the number of customers that end up purchasing j, and in such case a customer is unable to predict her net value or utility for any item j in advance. The price to be paid may also depend on other forms of pricing conditions, other than volume conditions, as described herein. However, given WTP values for each customer, embodiments described herein are operable to match customers to items in such a way that—given the discounts that accrue because of the sales volume for each item induced by the matching, or other pricing conditions that are met by the matching—each customer i may be matched to the item j that has greatest net value vᵢⱼ−pₜ^{j} for her (where τ₁^{j} is the pricing condition reached for item j).

Formally, a matching may be represented as an assignment function μ, where μ(i, j)=μᵢⱼ takes the value 1 if customer i (or customer preference set i) is assigned to buy item j, and takes the value zero otherwise. Note that a customer i can be assigned to buy no item in a matching, in which case μᵢⱼ=0 for all items j. In accordance with some embodiments—where a customer desires at most one item—a customer may be assigned to at most one item in any matching, so μᵢⱼ=1 for at most one item j. In other embodiments of the invention, a customer may be assigned to purchase one or more units of an item, or one or more units each of several distinct items.

### Individual Surplus Maximizing (or Myopically Stable) Matchings

Embodiments described herein may involve a segmentation/matching algorithm that assigns customers to items to achieve an individual surplus maximizing matching, namely, a matching that ensures that each customer purchases an item that maximizes their own utility. In some embodiments, once vendor pricing schedules and customer preference sets are received, an individual surplus maximizing matching is computed. The matching may also include the prices to be paid by each customer for each matched item. Individual surplus maximizing matchings may also be referred to as myopically stable matchings, since they may match customers to the items that maximize their utility at the item prices included in the matching. For myopic stability, the optimization of the objective function may be subject to a constraint that no customer would achieve a higher utility if matched to one or more units of one of more vendible items, at the prices for those items determined by the matching, different than the zero or more units matched to said customer at the price to be paid for the respective matched units.

In accordance with some embodiments, an individual surplus maximizing matching may be defined by first defining certain quantities of interest. Let I refer the set of customers and J refer to the set of items participating in the current event. We describe here algorithmic embodiments for which vendors offer volume discounts; the application to other forms of pricing conditions will be evident.
1. The quantity of item j sold in matching μ may be defined as qⱼ(μ)=Σ_{iε1}μᵢⱼ. Specifically, this quantity may be simply the number of customers for which the matching sets μᵢⱼ to one.
2. The price of item j in a matching μ may be defined as pⱼ(μ)=min {pₜ^{j}: qⱼ(μ)≧τₜ^{j}}. In other words, given that quantity qⱼ(μ) of item j may be sold in matching μ, the price may be the lowest discounted price pₜ^{j} offered for j such that the corresponding pricing condition τₜ^{j} is met or exceeded.

With these definitions in hand, a matching μ may be individual surplus maximizing whenever, for each customer i: (a) μᵢⱼ=1 only if vᵢⱼ−pⱼ(μ)≧v_{ij′}−p_{j′}(μ) for every pair of items j and j′; and (b) μᵢⱼ=1 only if vᵢⱼ−pⱼ(μ)>0. The first condition states that customer i may be matched to item j only if i's utility (or individual surplus) is maximized by this item given the discounted prices induced by the matching. In other words, this item may have greater utility than any other item j′ given the prices induced by μ. The second condition may further require that the matched item cannot have utility less than zero (otherwise, customer i would prefer not to be matched at all).

Embodiments described herein may use algorithmic means to find such a matching. In some embodiments, the solution to the matching problem may be expressed as an objective function that may be solved by particularly programming matching machine 12 with specific optimizing software, such as an integer program (IP) or mixed integer program (MIP) optimization software, such as the CPLEX optimizer available from IBM, or the FICO Xpress Optimization Suite from Fair Isaac Corp.

Utilitizing IP or MIP optimizing software may require concise, efficient problem formulations. The formulation may consist of describing one or more variables, one or more objective functions, and one or more constraints, to serve as input to the optimizing software, thereby causing it to output an individual surplus maximizing matching. Such a formulation is described herein, along with key variables and constraints.

Assignment variables (binary) may include μ_{ijd}, i ε I, j ε J, d≦Dⱼ, and may denote that customer i is matched to item j at the dth discount level for item j. Variables μ_{ijd}, i ε I, j ε J, may be defined indicating that i is matched to j.

Constraints may include:

$$\begin{matrix}{\sum }_{j ∈ J} {\sum }_{d \leq {D}_{j}} {μ}_{ijd} \leq 1 , ∀ i ∈ I . & ( 1 ) \\ {μ}_{ij} = {\sum }_{d \leq {D}_{j}} {μ}_{ijd} , ∀ i ∈ I , j ∈ J & ( 2 )\end{matrix}$$

Count variables (continuous) may include Nⱼ, j ε J which may indicate how many units of item j are matched to customers.

Additional constraints may include:

$${N}_{j} = {\sum }_{i ∈ I} {μ}_{ij} , ∀ j ∈ J \qquad ( 3 )$$

Binary threshold variables may include: Iₜ^{j}, d≧Dⱼ, j ε J, where Iₜ^{j} may indicate whether item j's dth pricing condition is met or exceeded. By having only one such threshold indicator be non-zero, this may ensure that the right price is selected during optimization.

Further constraints may include:

$$\begin{matrix}{τ}_{j}^{d} {I}_{j}^{d} \leq {N}_{j} , ∀ j ∈ J , d \leq {D}_{j} & ( 4 ) \\ {\sum }_{d}^{ } {I}_{j}^{d} = 1 , ∀ j ∈ J & ( 5 )\end{matrix}$$

Some embodiments may ensure a customer i is only matched to the achieved discount level for any item j using constraints:

μ_{ijd}≦Iⱼ^{d}, ∀i ε I, j ε J, d≦Dⱼ (6)

Individual surplus maximization and participation constraints may also be used which may ensure that i is matched to the item that maximizes its utility at achieved prices, and that this utility is non-negative. Constraints include:

$$\begin{matrix}{\sum }_{j ∈ J}^{ } {\sum }_{d \leq D}^{ } {μ}_{ijd} ( {v}_{ij} - {p}_{j}^{d} ) \geq {v}_{ij} ′ - {\sum }_{d \leq {D}_{j} ′}^{ } {I}_{{j}^{′}}^{d} {p}_{{j}^{′}}^{d} , ∀ i ∈ I , {j}^{′} ∈ J . & ( 7 ) \\ {\sum }_{j ∈ J}^{ } {\sum }_{d \leq D}^{ } {μ}_{ijd} ( {v}_{ij} - {p}_{j}^{d} ) \geq 0 ∀ i ∈ I . & ( 8 )\end{matrix}$$

Several different objective functions may be used for the matching. Examples include either of:

$$\begin{matrix}min {\sum }_{j ∈ J}^{ } {\sum }_{d \leq {D}_{j}}^{ } {p}_{j}^{d} {I}_{j}^{d} . & ( 9 ) \\ max {\sum }_{i ∈ I}^{ } {\sum }_{j ∈ J}^{ } {\sum }_{d \leq {D}_{j}}^{ } {μ}_{ijd} ( {v}_{ij} - {p}_{j}^{d} ) . & ( 10 )\end{matrix}$$

An objective function used for generating the matching may minimize the sum of the prices to be paid by the customers matched to items, for example, by using the formulation in Eqn. 9. An objective function used for generating the matching may maximize the sum of utilities of the customers matched to items, for example, by using the formulation in Eqn. 10. As noted above, a customer's utility may be the difference between the customer's WTP value for a matched item and the price to be paid for the item. As another example, the objective function used for generating the matching may maximize the utility for each customer individually, where a customer is matched to a vendible item that provides the customer with a greater utility than any other item offered. As another example, the objective function may be null or constant, not referring to any specific properties of the solution, but simply requiring that the matching be myopically stable (i.e., individually surplus maximizing). This null or constant objective can equivalently be formulated by as a maximization in which large penalties are specified for violating the myopic stability (or ISM) constraints, allowing the conversion of such constraints into an objective function. Maximizing and minimizing may refer to an optimal solution, a near optimal solution, an approximation, and so on. Further, minimization may be converted to maximization by adjusting the objective function accordingly, and vice versa.

In other embodiments, the solution of the MIP may be implemented by means of a partial linear programming (LP) relaxation, where this may be accomplished by allowing the assignment variables (binary) μ_{ijd}, i ε I, j ε J, d≦Dⱼ to take on any real value in the interval [0, 1] instead of insisting on integer values, and using matching machine 12 programmed with optimization software to solve this variant of the problem. An optimal solution may exist to this relaxed problem that assigns all such variables an “extreme” value of either 0 or 1; but the solution to this relaxed problem is typically much faster for many standard optimization software packages.

In yet other embodiments, the MIP is not solved to optimality, but the matching machine 12 (and in particular matching engine 24) programmed with optimization software may be terminated before completion with an approximate solution to the MIP that approximately minimizes the objective function given by Eq. 9, or approximately maximizes the objective function given by Eq. 10, or some other objective function that represents the objectives of the matching problem.

In yet other embodiments, the individual surplus maximization constraints, Eq. 7, may be relaxed by allowing the MIP to determine a solution that approximately satisfies said constraints. This approximate solution may be realized, for instance, by allowing a solution that matches one or more customers i to an item that is within some additive factor δᵢ of maximizing i's individual surplus. Said realization can be accomplished by replacing the constraints Eq. 7 with:

$${\sum }_{j ∈ J}^{ } {\sum }_{d \leq {D}_{j}}^{ } {μ}_{ijd} ( {v}_{ij} - {p}_{j}^{d} ) + {δ}_{i} \geq {v}_{{ij}^{′}} - {\sum }_{d \leq {D}_{{j}^{′}}}^{ } {I}_{{j}^{′}}^{d} {p}_{{j}^{′}}^{d} , ∀ i ∈ I , {j}^{′} ∈ J . \qquad ( 11 )$$

where δᵢ>0 is degree to which customer i's utility for said customer's matched item, if any, may be allowed to fall below said customer's utility for any other item at the prices determined by the matching. The terms δᵢ may be used for one, several, or all customers, and may be identical for each such customer, or may be different for different customers.

In yet other embodiments, the participation constraints, Eq. 8, may be relaxed by allowing the MIP to determine a solution that approximately satisfies said constraints. This approximate solution can be realized, for instance, by allowing a solution that matches one or more customers i to an item whose utility for i is no less than γᵢ, where γᵢ≦0 is the degree to which the matched item for customer i may have negative utility. Said realization can be accomplished by replacing the constraints Eq. 8 with:

$${\sum }_{j ∈ J}^{ } {\sum }_{d \leq {D}_{j}}^{ } {μ}_{ijd} ( {v}_{ij} - {p}_{j}^{d} ) \geq {γ}_{i} ∀ i ∈ I . \qquad ( 12 )$$

The terms γᵢ may be used for one, several, or all customers, and may be identical for each such customer, or may be different for different customers.

Still other embodiments may use in matching engine 24 algorithmic means other than linear programming or mixed integer programming to determine an exact or approximate individual surplus maximizing matching.

### Nash Stable Matchings

Some combinations of vendor pricing schedules and customer preferences may give rise to multiple individual surplus maximizing matchings. In other embodiments, additional or different selection criteria may be used to select a certain matching instead of other matchings. One example selection criterion is Nash stability, which provides a refined matching. A Nash stable matching μ is a matching in which no customer would prefer to buy a different item (or switch the item she is matched to) given the current matching of other customers in the matching. For Nash stability (which may also be referred to as “triggered” stability), the optimization of the objective function may be subject to a constraint that no customer would achieve higher utility if matched to one or more units of one of more vendible items different than the zero or more units matched to that customer, at the prices of the different vendible items that would be paid had the customer been matched to said different items. The stability may be approximate such that a utility of the customer that would be attained by being matched to one or more units of one of more vendible items different than the zero or more units matched to said customer at the prices of the different items that would be paid had this customer been matched to the different items, is greater than that of the utility of the customer of the matching by no more than a threshold.

While a Nash stable matching may be individual surplus maximizing, the converse may not be true. As an example, suppose that a customer i is matched with an item j in an individual surplus maximizing matching μ. By definition, i may achieve maximum utility by purchasing j at the current prices. However, by requesting instead to purchase an item j′ different from j, i may cause a new pricing condition to be reached for j′, thus lowering its price, and making it preferred to j. Thus, in such a matching, i may have a strong incentive to unilaterally “deviate” and attempt to join the subgroup or segment of the customer group that is purchasing j′. A stable matching removes this incentive by making assignments that may ensure that no customer can benefit from such a unilateral deviation.

A formal definition of a Nash stable matching may be given as follows. Let μ be some matching, and let μ[i→j] be a matching that is identical to μ for all customers different from i, but in which i is matched to item j. Matching μ may be Nash stable whenever, for each customer: (a) μᵢⱼ=1 only if vᵢⱼ−pⱼ(μ)≧v_{ij′}−p_{j′}(μ[i→j′]) for every pair of items j and j′; and (b) μᵢⱼ=1 only if vᵢⱼ−pⱼ(μ)≧0. The definition of Nash stability is similar to that for individual surplus maximization (i.e., myopic stability) except that the utility of customer i for her matched item j is at least as great as her utility for any other item j′, accounting for the potential change in price of j′ if i were instead matched to j′ (i.e., accounting for any new price that might be “triggered” by that switch).

In some embodiments, the Nash stability criterion may be used to select a matching of customers to items, and matching engine 24 may use algorithmic means to determine a stable matching. In other embodiments, the solution to the stable matching problem may be solved by programming matching engine 24 with optimizing software, such as an integer program (IP) or mixed integer program (MIP) optimization software, such as the CPLEX optimizer available from IBM, or the FICO Xpress Optimization Suite from Fair Isaac Corp. Utilizing IP or MIP optimizing software may require concise, efficient problem formulations. The formulation may consist of describing one or more variables, one or more objective functions, and one or more constraints, to serve as input to the matching engine 24 programmed with optimizing software, thereby causing it to output an individual surplus maximizing matching.

An example formulation may use the same variables, constraints, and objectives as in the formulation of the MIP for the individual surplus maximizing (or myopically stable) matching, with the exception that one new set of variables may be introduced and one set of constraints may be replaced. Specifically, the following variables and constraints may be added:

Binary threshold variables Ĩ\tilde{Iⱼ^{d}}, d≦Dⱼ, j ε J, where Ĩ\tilde{Iⱼ^{d}} may denote whether item j's dth pricing condition is met or exceeded if one additional customer is assigned (i.e., in the matching μ[i→j] (for any item j different from customer i's current match in μ).

Constraints may include:

$$\begin{matrix}{τ}_{j}^{d} {\tilde{I}}_{j}^{d} \leq {N}_{j} + 1 , ∀ j ∈ J , d \leq {D}_{j} & ( 13 ) \\ {\sum }_{d \leq {D}_{j}}^{ } {\tilde{I}}_{j}^{d} = 1 , ∀ j ∈ J & ( 14 ) \\ ( \vert I \vert + 1 ) {\tilde{I}}_{j}^{{D}_{j}} + {\sum }_{d < {D}_{j}}^{ } {τ}_{j}^{d + 1} {\tilde{I}}_{j}^{d} \geq {N}_{j} + 2 , ∀ j ∈ J . & ( 15 )\end{matrix}$$

Nash stability constraints may ensure that customer i does not prefer to be matched to an item different than its current matched item, even when accounting for the fact that this switch might decrease the price of this different item. Constraints may further include:

$${\sum }_{j ∈ J}^{ } {\sum }_{d \leq {D}_{j}}^{ } {μ}_{ijd} ( {v}_{ij} - {p}_{j}^{d} ) \geq {v}_{{ij}^{′}} - {\sum }_{d \leq {D}_{{j}^{′}}}^{ } {\tilde{I}}_{{j}^{′}}^{d} {p}_{{j}^{′}}^{d} - L {μ}_{{ij}^{′}} , ∀ i ∈ I , {j}^{′} ∈ J . \qquad ( 16 )$$

where L may denote some large constant that is larger than any possible item utility, and the term L μᵢⱼ may ensure that the stability constraint is trivially satisfied if j=j′. This set of constraints may replace the individual surplus maximization constraints, Eq. 7, in the ISM matching program.

In other embodiments, the solution of the MIP just described may be implemented in matching engine 24 by means of a partial linear programming (LP) relaxation, where this may be accomplished by allowing the assignment variables (binary) μ_{ijd}, i ε I, j ε J, d≦Dj to take on any real value in the interval [0, 1] instead of insisting on integer values, and using standard optimization software to solve this variant of the problem. An optimal solution may exist to this relaxed problem that assigns all such variables an “extreme” value of either 0 or 1; but the solution to this relaxed problem may be faster for some optimization software packages.

In yet other embodiments, the MIP may not be solved to optimality, but matching engine 24 programmed with the optimization software may be terminated before completion with an approximate solution to the MIP that approximately minimizes the objective given by Eq. 9, or approximately maximizes the objective given by Eq. 10.

In yet other embodiments, the stability constraints, Eq. 16, may be relaxed by allowing the MIP of matching engine 24 to determine a solution that approximately satisfies said constraints. This approximate solution may be realized, for instance, by allowing a solution that matches one or more customers i to an item that is within some additive factor δᵢ of maximizing i's individual surplus, accounting for potential price changes triggered by the assignment to a different item. Said realization can be accomplished, for example, by replacing the constraints Eq. 16 with:

$${\sum }_{j ∈ J}^{ } {\sum }_{d \leq {D}_{j}}^{ } {μ}_{ijd} ( {v}_{ij} - {p}_{j}^{d} ) + {δ}_{i} \geq {v}_{{ij}^{′}} - {\sum }_{d \leq {D}_{{j}^{′}}}^{ } {\tilde{I}}_{{j}^{′}}^{d} {p}_{{j}^{′}}^{d} - L {μ}_{{ij}^{′}} , ∀ i ∈ I , {j}^{′} ∈ J . \qquad ( 17 )$$

where δᵢ>0 is degree to which customer i's utility for said customer's matched item, if any, may be allowed to fall below said customer's utility for any other item, accounting for any change in price induced by assigning i to said other item. The terms δᵢ be used for one, several, or all customers, and may be identical for each such customer, or may be different for different customers.

In yet other embodiments, the participation constraints, Eq. 8, may be relaxed by allowing the matching engine 24 and the MIP to determine a solution that approximately satisfies said constraints. This approximate solution may be realized, for instance, by allowing a solution that matches one or more customers i to an item whose utility for i is no less than γᵢ, where γᵢ<0 is the degree to which the matched item for customer i may have negative utility. Said realization may be accomplished by replacing the constraints Eq. 8 with:

$${\sum }_{j ∈ J}^{ } {\sum }_{d \leq {D}_{j}}^{ } {μ}_{ijd} ( {v}_{ij} - {p}_{j}^{d} ) \geq {γ}_{i} ∀ i ∈ I . \qquad ( 18 )$$

The terms γ, can be used for one, several, or all customers, and can be identical for each such customer, or may be different for different customers.

In still other embodiments matching engine 24 may use algorithmic means other than linear programming or mixed integer programming to determine an exact or approximate individual surplus maximizing matching.

Matchings that Maximize the Sum of Customer Utilities using Transfers

In other embodiments, the total customer surplus (or sum of customer utilities) generated by a Nash stable matching or an individual surplus maximizing matching may be less than that attainable by some other matching. To illustrate, consider an example in which: both vendor A and B offer a base price of $9 for their items, and a discounted¹ price of $6 if three units are sold; two customers X and Y each have a value of $10 for A, and $4 for B; and one customer Z has a value of $4 for A and $10 for B. The only individual surplus maximizing (or stable) matching in this example assigns item A to X and Y, and item B to Z, giving a total utility of $3 ($1 for each customer). However, an alternative matching that assigns item A to all three customers may generate greater total utility. The discounted price of $6 for A means that both X and Y achieve greater individual utility of $4 each; however, Z now achieves negative utility of $−2. However, the total utility of all three customers of $6 is greater than in the individual surplus maximizing matching.

On the surface, Z may have no incentive to participate in such a matching, since she is paying more for A than it is worth to her. However, the extra surplus, achieved because X and Y now receive their preferred item at an even greater discount, can be used to subsidize the price offered to Z. For instance, the additional savings achieved by X and Y can be shared with Z by offering Z a price of $2 for A (instead of the vendor's discounted price of $6), where Z's price for A is subsidized by increasing the price to X and Y to $8. This would provide each customer with a net utility of $2; and all customers may be better off than they are in the individual surplus maximizing matching example.

For example, SW(μ) of a matching may be defined to be the sum of customer utilities induced by that matching:

$$SW ( μ ) = {\sum }_{i ∈ I , j ∈ J , {μ}_{ij} = 1}^{ } {v}_{ij} - {p}_{j} ( μ ) .$$

A matching μ maximizes the sum of customer utilities whenever SW(μ)≧SW(μ′) for any other matching μ′. In other words, μ generates total utility at least as great as any other matching.

In other embodiments, a matching maximizing the sum of customer utilities may be produced by matching engine 24 programmed with algorithmic means. If this matching is individual surplus maximizing or Nash stable, it may be adopted as the matching to output and the normal discounted prices may be charged to each customer. However, if it is not individual surplus maximizing, then matching engine 24 is operable to perform an additional step that determines adjusted prices for each individual that may ensure that the matching, using these adjusted prices, is individual surplus maximizing or stable.

In this embodiment, matching engine 24 programmed with algorithmic means may be used to determine a matching maximizing the sum of customer utilities and to determine necessary price adjustments. For example, the solution to the problem of finding a matching maximizing the sum of customer utilities may be solved by programming matching engine 24 with optimizing software, such as an integer program (IP) or mixed integer program (MIP) optimization software, such as CPLEX optimizer available from IBM, or the FICO Xpress Optimization Suite from Fair Isaac Corp. Utilitizing IP or MIP optimizing software may require concise, efficient problem formulations. The formulation may consist of describing one or more variables, one or more objective functions, and one or more constraints, to serve as input to the optimizing software, thereby causing it to output an individual surplus maximizing matching. Such a formulation is described next.

Key variables and constraints may include:.

Assignment variables (binary) μ_{ijd}, i ε I, j ≧J: which may indicate whether customer i is assigned to item j. Constraints may include:

$${\sum }_{j ∈ J}^{ } {μ}_{ij} \leq 1 , ∀ i ∈ I . \qquad ( 19 )$$

Count variables (continuous) Nⱼ, j ε J, may be defined as in the ISM program using constraints Eq. 3.

Binary threshold variables Iⱼ^{d}, jεJ, d≦D may be defined as in the ISM program using constraints Eq. 4 and Eq. 5.

The objective may be written in quadratic form:

$$max {\sum }_{i ∈ I}^{ } {\sum }_{j ∈ J}^{ } {v}_{ij} {μ}_{ij} - {\sum }_{j ∈ J}^{ } {\sum }_{d \leq {D}_{j}}^{ } {p}_{j}^{d} {I}_{j}^{d} {N}_{j} \qquad ( 20 )$$

where the first summation indicates total valuation of matching μ to all customers and the second summation indicates the total cost (or price paid) in the matching. The quadratic component iⱼ^{d} Nⱼ may be linearized in a standard way with an auxiliary variable zⱼ^{d} introduced to represent this component with the following constraints:

$$\begin{matrix}{Z}_{j}^{d} \leq {I}_{j}^{d} U , ∀ j ∈ J , d \leq {D}_{j} & ( 21 ) \\ {\sum }_{d = 1}^{D} {Z}_{j}^{d} = {N}_{j} , ∀ j ∈ J & ( 22 )\end{matrix}$$

where U may be some large constant that provides an upper bound on Nⱼ (e.g., U may be equal to N, the number of customers). The matching engine 24 and MIP may then use the following objective to compute the matching:

$$max {\sum }_{i ∈ I}^{ } {\sum }_{j ∈ J}^{ } {v}_{ij} {μ}_{ij} - {\sum }_{j ∈ J}^{ } {\sum }_{d \leq {D}_{j}}^{ } {p}_{j}^{d} {Z}_{j}^{d} \qquad ( 23 )$$

In other embodiments, the solution of the MIP just described may be implemented by means of a partial linear programming (LP) relaxation, where this may be accomplished by allowing the assignment variables (binary) μ_{ijd}, i ε I, j ε J, to take on any real value in the interval [0, 1] instead of insisting on integer values, and using optimization software to solve this variant of the problem. An optimal solution may exist to this relaxed problem that assigns all such variables an “extreme” value of either 0 or 1; but the solution to this relaxed problem may be faster for some optimization software packages.

In yet other embodiments, the MIP may not be solved to optimality, but the optimization software is terminated before completion with an approximate solution to the MIP that approximately maximizes the objective given by Eq. 23.

Still other embodiments of the matching engine 24 may use algorithmic means other than linear programming or mixed integer programming to determine an exact or approximate individual surplus maximizing matching.

As discussed above, the solution of the problem of a matching maximizing the sum of customer utilities may match a customer to an item, where the price for said item is higher than said customer's value for that item. In this way, one or more customers may have negative utility in a matching maximizing the sum of customer utilities. This means that such customers may be dissatisfied with the deal and are unlikely to continue participating in the event. In some embodiments, a matching maximizing the sum of customer utilities is acceptable even if one or more customers have negative utility. For example, when the customers are employees, or separate divisions, of a single company, such a matching may be desirable.

In other situations, allowing customers to be assigned to items at prices that give them negative utility is undesirable. In said situations, other embodiments may be used. By definition of a matching maximizing the sum of customer utilities, the total amount of such “negative utility” experienced by such customers may be at least (and typically more than) compensated for by the increase in utility experienced by other customers relative to any ISM or myopically stable matching. This means that the increase in utility experienced by other customers can be shared with customers whose utility is negative: this is accomplished by computing price adjustments to each customer's price for said customer's matched item, reflecting transfers from customers whose utility is greater than needed to ensure stability, and subsidizing the prices of customers with negative utility.

More precisely, for some embodiments, matching engine 24 may compute a social-welfare maximizing matching, and then compute personalized prices for each customer that may effectively transfer surplus from customers whose (positive) individual surplus is maximized in the matching to those whose individual surplus is not maximized by increasing the prices of those with maximizing surplus and subsidizing the prices of those with a non-maximizing surplus. These adjustments may be made to ensure that customers with a maximizing utility continue to maximize their individual surplus in the current matching, even when their personalized price for their matched item increases; and the subsidies to non-maximizing customers ensure that their surplus when their personalized price is decreased is maximized given this subsidy.

Formally, let μ* be a SW-maximizing matching, let μ*(i) be the item to which customer i is matched, and let p; denote the discounted price paid by for item j in matching μ*. For each customer i, we may categorize i as being an ISM customer in μ* if i's individual surplus is maximized; that is, if v_{iμ*(i)}−p_{u*(i)}≧vᵢⱼ−pⱼ* for all items j ε J. Any other customer is a non-ISM customer. Let I+ and I− denote the set of ISM and non-ISM customers (where I=I+, I−). Matching engine 24 may compute transfers to and from these customers as follows: for each customer i ε I⁻ compute a subsidy sᵢ, which is the amount by which her payment for her matched item will be reduced; specifically, her personalized price may be p_{u*(i)}ⁱ=p_{u*(i)}*−sᵢ. The subsidy sᵢ, may be greater than or equal to zero. For each customer i ε I⁺ matching engine 24 may compute a contribution cᵢ, which is the amount by which her payment for her matched item will be increased; specifically, her personalized price may be p_{u*(i)}ⁱ=p_{u*(i)}*+cᵢ. The contribution cᵢ may be greater than or equal to zero.

In such embodiments, these contributions and subsidies are computed by matching engine 24 programmed with algorithmic means. In some embodiments, the solution to the problem of finding a matching maximizing the sum of customer utilities is solved by programming matching engine 24 with optimizing software, such as linear program (LP) optimization software, such as CPLEX optimizer available from IBM, or the FICO Xpress Optimization Suite from Fair Isaac Corp. Utilitizing LP optimizing software may require concise, efficient problem formulations. The formulation may consist of describing one or more variables, one or more objective functions, and one or more constraints, to serve as input to the optimizing software, thereby causing it to output an individual surplus maximizing matching. Two such formulations are described herein.

The first formulation may find a set of transfers that minimizes the total amount transferred, while satisfying the conditions above. The following may be key variables, constraints, and the objective for the purpose of computing transfers.

Transfer variables (continuous) sᵢ, i ε I⁻ representing subsidies to non-ISM agents and cᵢ, i ε I′ representing contributions from ISM agents.

ISM constraints: these ensure each customer's individual surplus is maximized by its matched item given the personalized price for that item. Constraints:

v_{iμ*(i)}−p_{μ*(i)}*+sᵢ≧vᵢⱼ−pⱼ*, ∀i ε I⁻, ∀j ε J, j≠μ*(i). (24)

v_{iμ*(i)}−p_{μ*(i)}*−cᵢ≧vᵢⱼ−pⱼ*, ∀i ε I⁺, ∀j ε J, j≠μ*(i). (25)

An example objective may minimize the sum of all contributions and the sum of all subsidies, and may be expressed as:

$$min {\sum }_{i ∈ {I}^{+}}^{ } {c}_{i} + {\sum }_{i ∈ {I}^{-}}^{ } {s}_{i} \qquad ( 26 )$$

A second formulation may find a set of transfers that minimizes the largest transfer to or from any individual customer. The following may be key variables, constraints, and the objective:

Transfer variables (continuous) sᵢ, i ε I⁻ and cᵢ, i ε I⁻ as above.

ISM constraints: as above.

Variable ε representing the maximum transfer. It has the constraints:

ε≧sᵢ, ∀i ε I⁻

ε≧cᵢ, ∀iεI+

An example objective function may minimize the amount transferred between customers, and may be expressed as:

min ε (27)

In another embodiment, the LPs described above for computing subsidies and contributions may not be solved to optimality, but the optimization software is terminated before completion with an approximate solution to the LP that approximately minimizes the objective given by Eq. 26, or approximately maximizes the objective given by Eq. 27.

In yet other embodiments, the individual surplus maximizing constraints, Eq. 24 and Eq. 25, may be relaxed by allowing the LP to determine a solution that approximately satisfies said constraints. This approximate solution can be realized, for instance, by allowing a solution that computes subsidies sᵢ or contributions cᵢ that are within some additive factor δᵢ of maximizing i's individual surplus. For example, said realization can be accomplished by replacing the constraints Eq. 24 and Eq. 25 with:

v_{iμ*(i)}−p_{μ*(i)}*+sᵢ+δᵢ≧vᵢⱼ−pⱼ*, ∀i ε I⁻, ∀j ε J, j≠μ*(i). (28)

v_{iμ*(i)}−p_{μ*(i)}*−cᵢ+δᵢ≧vᵢⱼ−pⱼ*, ∀i ε I⁺, ∀j ε J, j≠μ*(i). (29)

where δᵢ≧0 is degree to which customer i's utility for said customer's matched item, if any, is allowed to fall below said customer's utility for any other item at current prices. The terms δᵢ may be used for one, several, or all customers, and may be identical for each such customer, or may be different for different customers.

Still other embodiments of the matching engine 24 may use algorithmic means other than linear programming to determine an exact or approximate individual surplus maximizing matching.

Still other embodiments may use algorithmic means to determine subsidies and contributions that satisfy different constraints or maximize some other objectives. Such other constraints include, but are not limited to, computing personalized prices that split the additional surplus realized by using the matching maximizing the sum of customer utilities evenly among all customers assigned items, or using some other fairness criterion.

Matching Maximizing Sum of Customer Utilities with No Subsidies

In yet other embodiments, matching engine 24 is operable to produce a matching maximizing the sum of customer utilities without allowing subsidized prices. In other words, every customer matched to a specific item j must pay the same (possibly discounted) price for j, based on the pricing condition achieved by the matching. However, any customer may “opt out” of the event, and purchase her most undiscounted-preferred item, namely, that item that maximizes her utility assuming no discounts of any prices. Let Uᵢ=maxⱼ vᵢⱼ−p₀^{j} denote customer i's undiscounted utility for her most undiscounted-preferred item. This denotes the maximum utility i can attain by abstaining from the event and purchasing her most preferred item at an undiscounted price.

In this embodiment, a matching maximizing the sum of customer utilities is found subject to the constraint that no customer's utility for her matched item is less than her undiscounted utility for her most undiscounted-preferred item. Such a matching is referred to as a matching maximizing the sum of customer utilities with no subsidies. In such a matching every customer has incentive to participate in the matching, so no monetary transfers (or subsidies) are needed. Additionally, the total utility attained by all participants in the matching is maximized.

In this embodiment, algorithmic means are used to determine a matching maximizing the sum of customer utilities with no subsidies. In one embodiment, the solution to the matching maximizing the sum of customer utilities with no subsidies problem is solved by programming matching engine using optimizing software, such as an integer program (IP) or mixed integer program (MIP) optimization software, such as CPLEX optimizer available from IBM, or the FICO Xpress Optimization Suite from Fair Isaac Corp. Utilizing IP or MIP optimizing software may require concise, efficient problem formulations. The formulation may consist of describing one or more variables, one or more objective functions, and one or more constraints, to serve as input to the optimizing software, thereby causing matching engine 24 to output a matching maximizing the sum of customer utilities subject to the undiscounted participation constraint.

Let Uᵢ denote customer i's maximum undiscounted utility. The algorithmic means of may combine elements of the ISM program and the program for maximizing sum of customer utilities:

Assignment variables (binary) μ_{ijd}, i ε I, j ε J, d≦Dⱼ, may denote whether customer i is matched to item j at the dth discount level for item j. From these variables μᵢⱼ, i ε I, j ε J, may indicate that i is matched to j. Constraints may include:

$$\begin{matrix}\begin{matrix}{\sum }_{j ∈ J} {\sum }_{d \leq {D}_{j}} {μ}_{ijd} \leq 1 , & ∀ i ∈ I .\end{matrix} & ( 30 ) \\ \begin{matrix}{μ}_{ij} = {\sum }_{d \leq {D}_{j}} {μ}_{ijd ,} & ∀ i ∈ I , j ∈ J .\end{matrix} & ( 31 )\end{matrix}$$

Count variables (continuous) Nⱼ, j ε J, may indicate how many units of item j are matched to the customers in the customer group. Constraints may further include:

$${N}_{j} = {\sum }_{i ∈ I} {μ}_{ij} , ∀ j ∈ J \qquad ( 32 )$$

Binary threshold variables Iⱼ^{d}, d≦Dⱼ, jεJ, where Iⱼ^{d} may denote whether j's dth pricing condition is exceeded. By allowing only one threshold indicator be nonzero, this may ensure that the right price is selected during optimization. Constraints may include:

$$\begin{matrix}\begin{matrix}{τ}_{j}^{d} {I}_{j}^{d} \leq {N}_{j} , & ∀ j ∈ J , d \leq {D}_{j}\end{matrix} & ( 33 ) \\ \begin{matrix}{\sum }_{d \leq {D}_{j}} {I}_{j}^{d} = 1 , & ∀ j ∈ J\end{matrix} & ( 34 )\end{matrix}$$

To ensure i is only matched to the achieved discount level for any item j, constraints may further include:

μ_{ijd}≦Iⱼ^{d}, ∀i ε I, j ε J, d≦Dⱼ. (35)

Non-discounted participation constraints may ensure that no customer's utility is less than Uᵢ, her maximum undiscounted utility. These constraints may include:

$$\begin{matrix}{\sum }_{j ∈ J} {\sum }_{d \leq {D}_{j}} {μ}_{ijd} ( {v}_{ij} - {p}_{j}^{d} ) \geq {U}_{i} , & ∀ i ∈ I .\end{matrix} \qquad ( 36 )$$

Auxiliary variables zⱼ^{d}, jεJ, d≦Dⱼ, may be introduced to represent the quantity Iⱼ^{d} Nⱼ, with the following constraints:

$$\begin{matrix}\begin{matrix}{Z}_{j}^{d} \leq {I}_{j}^{d} U , & ∀ j ∈ J , d \leq {D}_{j}\end{matrix} & ( 37 ) \\ \begin{matrix}{\sum }_{d = 1}^{{D}_{j}} {Z}_{j}^{d} = {N}_{j} , & ∀ j ∈ J\end{matrix} & ( 38 )\end{matrix}$$

where U may be an upper bound on Nⱼ (e.g., U may be equal to N, the number of customers).

The following example objective function may be used to compute the matching:

$$max {\sum }_{i ∈ I} {\sum }_{j ∈ J} {v}_{ij} {μ}_{ij} - {\sum }_{j ∈ J} {\sum }_{d \leq {D}_{j}} {p}_{j}^{d} {Z}_{j}^{d} \qquad ( 39 )$$

In another embodiment, the solution of the MIP just described is implemented by means of a partial linear programming (LP) relaxation, where this may be accomplished by allowing the assignment variables (binary) μ_{ijd}, i ε I, j ε J, d≦Dⱼ, to take on any real value in the interval [0, 1] instead of insisting on integer values, and matching engine 24 using optimization software to solve this variant of the problem. An optimal solution may exist to this relaxed problem that assigns all such variables an “extreme” value of either 0 or 1; but the solution to this relaxed problem may be faster for many optimization software packages.

In yet another embodiment, the MIP may not be solved to optimality, but the optimization software may be terminated before completion with an approximate solution to the MIP that approximately maximizes the objective given by Eq. 39.

In yet other embodiments, the non-discounted participation constraints, Eq. 36, are relaxed by allowing the MIP to determine a solution that approximately satisfies said constraints. This approximate solution can be realized, for instance, by allowing a solution that matches one or more customers i to an item that is within some additive factor δᵢ of maximizing i's individual surplus, accounting for potential price changes triggered by the assignment to a different item. Said realization may be accomplished by replacing the constraints Eq. 36 with:

$$\begin{matrix}{\sum }_{j ∈ J} {\sum }_{d \leq {D}_{j}} {μ}_{ijd} ( {v}_{ij} - {p}_{j}^{d} ) + {δ}_{i} \geq {U}_{i} , & ∀ i ∈ I .\end{matrix} \qquad ( 40 )$$

where δᵢ≧0 is degree to which customer i's utility for said customer's matched item, if any, is allowed to fall below said customer's utility for any other item. The terms δᵢ can be used for one, several, or all customers, and can be identical for each such customer, or may be different for different customers.

Still other embodiments of the matching engine may use algorithmic means other than linear programming or mixed integer programming to determine an exact or approximate individual surplus maximizing matching.

Stable Matchings with Qualitative Rankings

In further embodiments, matching engine 24 may produce a matching that does not require customers to specify willingness to pay for specific items. Since each vendor offers a finite set of discounted prices, in such embodiments, the customers may simply rank at least some combinations of deals, where by a deal we refer to a pair or combination (j, p), where j is an item offered for sale in the event, and p is one of the discounted prices offered by the vendor of item j should a certain volume threshold (or other pricing conditions) be achieved. In this embodiment, customer preference sets are received from one of more customers which may include such ranking. A customer may also indicate a set of deals to which she does not want to be matched.

For example, suppose a treatment at Spa A is offered for a base price of $65; and a discounted price of $35 if 50 customers purchase this treatment. And suppose Spa B is offered for a base price of $50; and a discounted price of $30 if 80 customers purchase this treatment. In this instance, there are four deals, or item-price combinations. A customer may indicate that she prefers (A, 35) to (B, 30) to (B, 50) to (A, 65). Such preferences would be reasonable for example, if A were “worth” $70 to her and B were worth $60. If the customer is unwilling to purchase certain deals (e.g., her least preferred deal, A for $65), she may also indicate this fact.

For this embodiment, matching machine 12 receives such customer preference sets from customers, and determines a qualitative stable matching (QSM), a property defined as follows. Given a matching μ, we say a deal (A, p) is active in μ iff p is the price of item A in matching μ (as defined earlier). Each item may be part of at most one active deal. Matching μ is then qualitatively stable iff, for every customer i, (a) if i is matched to item A, then the active deal (A, p) for A is preferred by i to any other active deal in μ; and (b) if i is unmatched to any item, then i is unwilling to purchase any active deal in μ.

In this embodiment, algorithmic means may be used to determine a qualitative stable matching. For example, the solution to the qualitative stable matching problem may be solved by matching engine 24 using optimizing software, such as an integer program (IP) or mixed integer program (MIP) optimization software, such as CPLEX optimizer available from IBM, or the FICO Xpress Optimization Suite from Fair Isaac Corp. Utilizing IP or MIP optimizing software requires concise, efficient problem formulations. The formulation may consist of describing one or more variables, one or more objective functions, and one or more constraints, to serve as input to the matching engine 12 programmed with optimizing software, thereby causing it to output a qualitative stable matching subject to the undiscounted participation constraint.

In on embodiment, the matching engine may receive a complete or partial ranking Rᵢ of one or more possible deals, with each ranking associated with a customer i. A score R_{ijd} may be assigned to each deal (j, d), and may require that: (a) the score R_{ijd} be positive if (j, d) is acceptable to i; (b) the score R_{ijd} be negative if (j, d) is unacceptable to i (or unranked by i); and (c) R_{ijd}>R_{ij′d′} if i prefers deal (j, d) to deal (j′, d′).

Assignment variables (binary) μ_{ijd}, i ε I, j ε J, d≦Dⱼ may indicate that customer i is matched to item j at the dth discount level for item j. From these, variables μ_{ijd}, i ε I, j ε J, may also be defined, indicating that i is matched to j. Constraints may include:

$$\begin{matrix}\begin{matrix}{\sum }_{j ∈ J} {\sum }_{d \leq {D}_{j}} {μ}_{ijd} \leq 1 , & ∀ i ∈ I .\end{matrix} & ( 41 ) \\ \begin{matrix}{μ}_{ij} = {\sum }_{d \leq {D}_{j}} {μ}_{ijd} , & ∀ i ∈ I , j ∈ J .\end{matrix} & ( 42 )\end{matrix}$$

Count variables (continuous) Nⱼ, j ε J, may indicate how many units of item j are assigned to the customer group. Constraints may further include:

$$\begin{matrix}{N}_{j} = {\sum }_{i ∈ I} {μ}_{ij} , & ∀ j ∈ J\end{matrix} \qquad ( 43 )$$

Binary threshold variables Iⱼ^{d}, d≦Dⱼ, jεJ, may indicate whether item j's dth pricing condition is met or exceeded. By allowing only one threshold indicator be nonzero, this may ensure that the right price is selected during optimization. Constraints may include:

$$\begin{matrix}\begin{matrix}{τ}_{j}^{d} {I}_{j}^{d} \leq {N}_{j} , & ∀ j ∈ J , d \leq {D}_{j}\end{matrix} & ( 44 ) \\ \begin{matrix}{\sum }_{d} {I}_{j}^{d} = 1 , & ∀ j ∈ J\end{matrix} & ( 45 )\end{matrix}$$

Constraints may be used to ensure customer i is only matched to the achieved discount level for any item j. Constraints may include:

μ_{ijd}≦Iⱼ^{d}, ∀i ε I, j ε J, d≦Dⱼ. (46)

Stability constraints may ensure that no customer is matched to an item unless this is her most preferred active deal. Constraints may further include:

$$\begin{matrix}{\sum }_{j ∈ J} {\sum }_{d \leq {D}_{j}} {μ}_{ijd} {R}_{ijd} \geq {\sum }_{d \leq {D}_{j}} {I}_{{j}^{′}}^{d} {R}_{{ij}^{′} d} & ∀ i ∈ I , {j}^{′} ∈ J ,\end{matrix} \qquad ( 47 )$$

Participation constraints may ensure that no customer is matched to an item unless the deal is acceptable. Constraints may include:

$$\begin{matrix}{\sum }_{j ∈ J} {\sum }_{d \leq {D}_{j}} {μ}_{ijd} {R}_{ijd} \geq 0 & ∀ i ∈ I .\end{matrix} \qquad ( 48 )$$

The following objective may be used by the matching engine:

$$min {\sum }_{j ∈ J} {\sum }_{d \leq {D}_{j}} {I}_{j}^{d} {p}_{j}^{d} . \qquad ( 49 )$$

and may ensure that the right discounted prices are set for each item.

In other embodiments, the solution of the MIP just described may be implemented by means of a partial linear programming (LP) relaxation, which may be accomplished by allowing the assignment variables (binary) μ_{ijd}, i ε I, j ε J, d≦Dj to take on any real value in the interval [0, 1] instead of insisting on integer values, and using standard optimization software to solve this variant of the problem. An optimal solution may exist to this relaxed problem that assigns all such variables an “extreme” value of either 0 or 1; but the solution to this relaxed problem may be typically much faster for many standard optimization software packages.

In yet another embodiment, the MIP may not be solved to optimality, but the optimization software may be terminated before completion with an approximate solution to the MIP that approximately maximizes the objective given by Eq. 39.

In yet other embodiments, the stability constraints, Eq. 47, may be relaxed by allowing the MIP to determine a solution that approximately satisfies the constraints. This approximate solution may be realized, for instance, by allowing a solution that matches one or more customers i to an item that is within some additive factor δᵢ of maximizing the score R of i's matched deal, Said realization may be accomplished by replacing the constraints Eq. 47 with:

$$\begin{matrix}{\sum }_{j ∈ J} {\sum }_{d \leq {D}_{j}} {μ}_{ijd} {R}_{ijd} + {δ}_{i} \geq {\sum }_{d \leq {D}_{j}} {I}_{{j}^{′}}^{d} {R}_{{ij}^{′} d} & ∀ i ∈ I , {j}^{′} ∈ J .\end{matrix} \qquad ( 50 )$$

where δᵢ≧0 is degree to which customer is score for said customer's matched deal, if any, is allowed to fall below said customer's score for any other deal. The terms δᵢ can be used for one, several, or all customers, and may be identical for each such customer, or may be different for different customers.

In yet other embodiments, the participation constraints, Eq. 48, may be relaxed by allowing the MIP to determine a solution that approximately satisfies said constraints. This approximate solution can be realized, for instance, by allowing a solution that matches one or more customers i to a deal that whose score R is within γᵢ of the score of the deal with the highest score for i. Said realization may be accomplished by replacing the constraints Eq. 48 with:

$$\begin{matrix}{\sum }_{j ∈ J} {\sum }_{d \leq {D}_{j}} {μ}_{ijd} {R}_{ijd} + {γ}_{i} \geq 0 & ∀ i ∈ I .\end{matrix} \qquad ( 51 )$$

The terms γᵢ may be used for one, several, or all customers, and may be identical for each such customer, or may be different for different customers.

Still other embodiments, matching engine 24 may use algorithmic means other than linear programming or mixed integer programming to determine an exact or approximate qualitatively stable matching.

For some embodiments, customers may rank deals arbitrarily. In other embodiments, a quasi-linearity assumption may be enforced, preventing customers from specifying a preference for a deal (A, p), involving a specific item A at some price p, over a deal (A, p′), involving the same item at a higher price p′>p. Other embodiments may permit customers to specify preferences for only some of the deals. In some such embodiments, customers may only be matched to deals for which they have specified preferences. In other embodiments, deals for which no preferences are specified, but for which at least some preference can be inferred (e.g., due to quasi-linearity), then a matching to such a deal may be proposed by the matching engine. For example, if (A, p) is deemed acceptable by customer i, and preferred to some other deal (B, q), then the matching machine 12 may infer that (A, p′), where p′ is a lower price than p, is also acceptable and also preferred to (B, q).

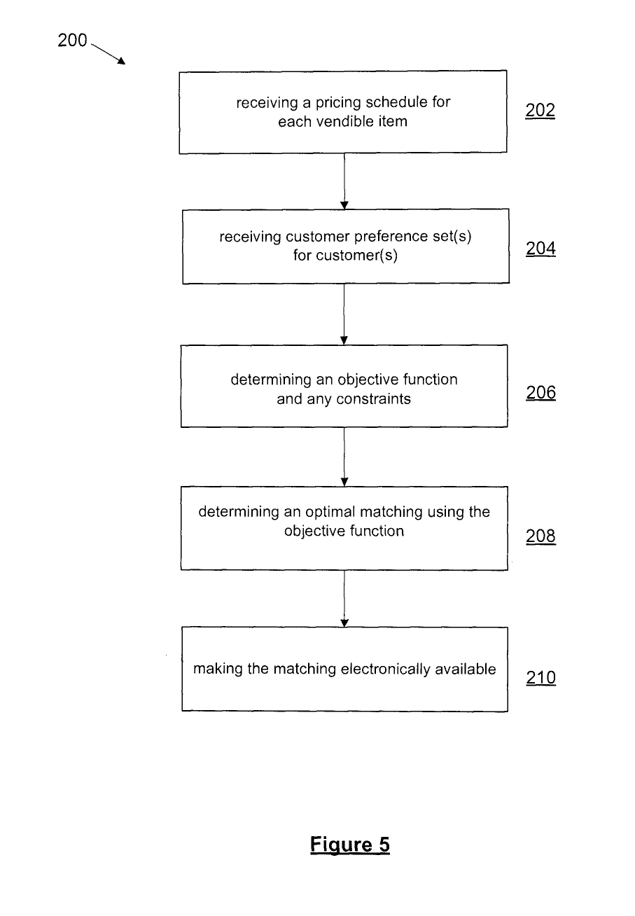

Referring now to FIG. 5, there is shown a flow diagram of a computer implemented method 200 of providing a matching of customers to vendible items, which may be implemented by matching machine 12 for example.

At 202, matching machine 12 receives a pricing schedule for each vendible item. The vendible items may be offered by one or more vendors for a given event. Each pricing schedule may be received in various formats, such as a vector, array, deal pairings, and so on. Each pricing schedule may comprise pricing conditions for the respective vendible item, and for each of pricing condition, a corresponding price for the respective vendible item. At least one pricing condition will be a nontrivial pricing condition that is not always satisfied, and not always true or false.

In some embodiments, the pricing conditions include volume thresholds indicating that the corresponding discounted price will be offered if the matching matches customers to at least the number of units of said item indicated by the volume threshold.

Further, in some embodiments, the prices include discounted prices which comprise absolute prices to be offered if the matching matches customers to at least the number of units indicated in the corresponding volume pricing condition for the respective vendible item. In other embodiments, the prices include discounted prices comprise percentage or fractional discounts, where said percentage or fractional discounts are applied to a base price of the respective vendible item if the matching matches customers to at least the number of units indicated in the corresponding volume pricing condition for the respective vendible item.

At 204, matching machine 12 receives customer preference sets from a customer group of one or more customers. Each customer preference set may be associated with a customer of the customer group. The customer preference sets may describe customer preferences for purchasing one or more units of the at least two vendible items. One customer may provide a single customer preference set or multiple customer preference sets. Customer preference sets may be received by matching machine 12 in a variety of formats, examples of which are described herein. For example, customer preference set may be in the form of a valuation function that outputs the value (e.g. WTP) a customer associates with a particular item.

For example, customer preference sets may include a customer's preference to purchase one vendible item over at least one other vendible item, or a WTP value for one or more units of the vendible item. As another example, customer preference sets may include a preference to purchase one vendible item at a particular price over another vendible item at a particular price.

As another example, a deal is a combination of one or more units of a vendible item and a particular price for the one or more units of the vendible item. The customer preference set comprises a ranking of one or more deals, where the utility of the customer group is based on the ranking of deals, and where the matching matches the zero or more customer preference sets to zero or more deals. As another example, a customer preference set may include a rating of one of more deals, for example, on a pre-specified scale (such as 1 to 5), or using “likes” and “dislikes,” or approvals and disapprovals.

Other embodiments may allow customers to partially specify their preferences or WTP for items participating in the event, or partially specify their preferences for deals. Or the customer preferences received from some data source(s) may be partial. For some embodiments, rather than specifying a precise willingness to pay for each item participating in the event, received customer preference sets may include, for zero or more such items, a range that may include said customer's true willingness to pay. This range may consist of a lower bound lb on her willingness to pay, and an upper bound ub on her willingness to pay, with ub≧ub. If a customer preference set includes no range for a specific item, a default range may be supplied for said item. If the customer specifies a precise willingness to pay w, this may be treated by setting ub=ub=w.

For this embodiment, matching engine 24 is operable to find a matching satisfying the constraints and objectives described earlier. Matching engine 24 is operable to select for each customer and each item a specific willingness to pay value within the range provided by said customer for said item, and compute a matching using one of the methods described herein.

Matching engine 24 is operable to select said willingness to pay from the range of values using probabilistic estimates, or other information, that maximizes the odds of finding a good matching, or minimizes some error measure.

For some embodiments, rather than specifying a precise willingness to pay for each item participating in the event, a customer specifies, for zero or more such items, a ranking of said items, where the ranking of a first item over a second item is taken to mean that the customer's willingness to pay for the first item is greater than her willingness to pay for the second item. In one embodiment of the invention, unranked items are treated as having lower willingness to pay than any ranked item. The ranking may also be a ranking of deals, where a deal is combination of an item and a particular price for the item.

For this embodiment, matching engine 24 is operable to find a matching satisfying the constraints and objectives described earlier. Matching engine 24 is operable to select for each customer and each item a specific WTP value, such that the willingness to pay value for a first item which is ranked higher than a second item is higher than the selected WTP value for said second item. Matching engine 24 is operable to then compute a matching using one of the methods described above.

Matching engine 24 is operable to select said willingness to pay from the range of values using probabilistic estimates, or other information, that maximizes the odds of finding a good matching, or minimizes some error measure.

In an embodiment in which a partial customer preference set is received from customers, the matching machine 12 may, in addition, request additional customer preferences to augment one or more customer preference sets, and receive additional preferences from one or more customers, or from data source(s) containing such preference information. Said request for additional information may be determined in order to improve some measure of the quality of the matching obtained using any previous and additional received partial customer preference set. Such measures of quality may include, but are not limited to: overall sum of customer utilities; degree of satisfaction of participation constraints; degree of satisfaction of individual surplus maximization constraints; or degree of satisfaction of stability constraints.

After requesting said additional customer preferences, matching machine 12 may find a matching satisfying the constraints and objectives described earlier, using the customer preference sets that contain both any prior received customer preferences in conjunction and any customer preferences received in response to said request.

Matching engine 24 is operable to select said additional requested preferences using probabilistic estimates, or other information, that maximizes the odds of finding a good matching, or minimizes some error measure.

The step requesting additional customer preference information, and augmenting the customer preference sets of the corresponding customers with any addition preference information so received, may be repeated until some termination criterion is met. Said termination criteria may include, but are not limited to: computing a matching whose measure of quality meets or exceeds some threshold; meeting or exceeding a threshold on the number of queries to or amount of customer preference set requested from one or more customers; meeting or exceeding some time limit.

At 206, matching engine 24 is operable to determine an objective function, examples of which are provided herein. The objective function measures utility of the customer group when zero or more customer preference sets are matched to one or more units of at least one vendible item of the at least two vendible items. When zero customer preferences sets are matched then this may be referred to as a null match, and indicates that the customer preference set is not matched with any item. The objective function measures the utility based on the customer preference sets and the pricing schedules. The objective function is used to evaluate and compute an optimal matching that aims to satisfy the objective defined by the objective function. The objective function measures the utility based on the received customer preference sets and received pricing schedules. In some embodiments, the utility of a customer may be a value the customer receives from purchasing a vendible item at a particular price. As another example, the utility of a customer for a vendible item may be the difference between the WTP value for the vendible item and a price to be paid for the item.

In some embodiments, the objective function comprises one or more constraints to preclude one or more matchings of customer preference sets to units of vendible items from being an optimal matching. Example constraints are described herein and include customer budgetary constraints, customer capacity constraints, vendible item capacity constraints, vendible item budgetary constraints.

In some embodiments, each customer preference set corresponds to a customer of the customer group, and the utility of a customer is a value the customer realizes from purchasing the zero or more units matched to each customer preference set corresponding to that customer at the price to be paid for the respective matched units. The utility of the customer group may be based on the utility of the customers of the customer group.

In some embodiments, the objective function maximizes the utility of the customer group, where the utility of the customer group comprises a sum of utilities of all customers. The customer preference set may include a WTP value for one or more units of at least one vendible item of the at least two vendible items. The utility the customer realizes from purchasing the zero or more units matched to each customer preference set corresponding to that customer is the difference between the WTP value for zero or more units matched to each customer preference set and the price to be paid for the respective matched units. The maximization may be an approximate maximization which permits the utility of the customer group to be less than a maximum utility of the customer group by at most some threshold. In some examples, the customer group comprises at least two customers and each customer may be assigned a weight factor, where the weight factor of at least one customer is different than the weight factor of at least one other customer. The utility of the customer group may be a weighted sum of utilities of all customers of the customer group, where the weighted sum is based on the weight factors. For example, an important customer may be assigned a large weight so that its utility is considered more than other customer utilities. This weighting may be useful when a matching service employing the matching engine desires to provide preferred services or better discounts to a preferred customer. This weighting may also prove useful when a customer submitting multiple customer preference sets, for example a large business submitting the preference sets for several different of its business units, desires that the matching favor certain of its customer preference sets (e.g., those of more valuable business units) than others.

In some embodiments, the objective function may minimize a sum of the prices to be paid by the customers in the customer group. In other embodiments, the objective function may maximize the utility for each customer in the customer group individually, where a customer is matched to a vendible item that provides the customer with a greater utility than any other vendible item given the prices stipulated in the pricing schedules and as determined by the matching. In further embodiments, the objective function may maximize a sum of utilities of the customers in the customer group. A customer's utility may be the difference between the customer's willingness to pay (WTP) for the zero or more units of the zero or more matched vendible items and the price to be paid for said vendible items. In even further embodiments, the objective function may maximize a difference between a total utility of all customers and a total price to be paid for all matched vendible items.

At 208, matching engine 24 is operable to determine, using the objective function, an optimal matching of zero or more customer preference sets to zero or more units of at least one vendible item of the at least two vendible items. The matching comprises, for each customer preference set matched to one or more units of the at least one vendible item, a price to be paid for the respective matched units. The price is based on the pricing schedule for the respective matched units of at least one vendible item. As noted herein, the matching may match a customer preference set to zero items, in which case the customer preference set is not matched to any items. In some embodiments, the matching only matches the customer to one or more units of any of the vendible items if it maximizes the customer's utility. The customer's utility may be the difference between said customer's WTP for said matched vendible item and the price to be paid for said vendible item.

As noted herein, the matching may be stable. For example, the matching may have myopic stability (i.e., be individually surplus maximizing), where the maximization is subject to a constraint that no customer would achieve a higher utility if matched to one or more units of one of more vendible items different than the zero or more units matched to that customer preference set, at the price to be paid for the respective matched units. This stability may be approximate in that the utility of the customer that would be attained by being matched to one or more units of one of more products different than the zero or more units matched to each customer preference set corresponding to that customer, at the prices of the matching, is greater than that of the utility of the matching by no more than a threshold. As another example, matching may have Nash stability in that the maximization is subject to a constraint that no customer would achieve higher utility if matched to one or more units of one of more vendible items different than the zero or more units matched to that customer preference set, at prices of the different vendible items that would be paid had the customer been matched to the different items. This Nash stability may also be approximate such that the utility of the customer that would be attained by being matched to one or more units of one of more vendible items different than the zero or more units matched to that customer preference set, at the prices of the different items that would be paid had the customer preference set been matched to the different items, is greater than that of the utility of the customer of the matching by no more than a threshold. As a further example, the matching may have group stability in that the maximization or optimization is subject to a constraint that no group of one or more customers would individually or jointly (collectively) achieve higher utility if matched to one or more units of one or more vendible items different than the zero or more units matched to each customer preference set corresponding to that customer, at the prices of the different vendible items that would be paid had said customer preference sets been matched to the different items. The group stability may also be approximate such that a utility of the customer that would be attained by being matched to one or more units of one of more vendible items different than the zero or more units matched to each customer preference set corresponding to the customers of the group, is greater than that of the utility attained by the customers of the group of the matching by no more than a threshold.

The matching may include the price to be paid by each customer for each matched item. In some embodiments, the price to be paid by a customer for each unit of the matched items is personalized, and may be different from the prices paid by other customers for each unit of the at least two vendible items, and may be different from prices of the pricing schedule. The personalized prices may be computed by, for example, computing subsidies to be paid to one or more customers for the one or more units of the items to which the customer is matched, wherein this subsidy will be applied to reduce the price for each unit of the items to which said customer is matched by the amount of the subsidy computed for said customer; computing contributions to be paid by one or more customers for the one or more units of the items to which the customer is matched, wherein this contribution will be applied to increase the price for each unit of the item to which said customer is matched by the amount of the subsidy computed for said customer; and where the total of all subsidies does not exceed the total of all contributions.

For some embodiments, the objective function may minimize a sum of all the subsidies and a sum of all contributions.

The personalized prices may be computed by transferring amounts between customers and the objective function may minimize a total of all amounts transferred.

For some embodiments, the matching matches a customer to one or more units of any of the at least two vendible items only if the match maximizes the customer's utility, where the customer utility is the difference between said customer's WTP for the matched item and the personalized price to be paid for the item, where said personalized price is determined by applying a contribution or subsidy.

For further embodiments, the matching matches a customer to one or more units of any of the at least two vendible items only if the matching approximately maximizes the customer's utility, wherein the customer utility is the difference between said customer's WTP for the matched item and the personalized price to be paid for the item, where the personalized price is determined by applying a contribution or subsidy; and the approximate maximization permits the matching of the customer to one or more units of any of the at least two vendible items whose utility is less than that of some other item by at most some threshold.

For some embodiments, the personalized prices minimize the total of all subsidies and contributions applied, subject to a constraint that each customer's utility is maximized. The personalized prices may minimize the size of a largest subsidy or contribution applied, subject to a constraint that each customer's utility is maximized.

For some embodiments, the matching matches a customer to one or more units of any of the vendible items only if the matching approximately maximizes the customer's utility, where customer utility is the difference between said customer's WTP for the matched one or more units of any of the vendible items and the price to be paid for the one or more units of any of the vendible items; where the approximate maximization permits the matching of said customer to one or more units of any of the vendible items whose utility is less than that of some vendible item by at most some threshold.

For other embodiments, the matching matches a customer to one or more units of any of the vendible items only if the matching maximizes the customer's utility, wherein customer utility for the one or more units of the vendible items is the difference between said customer's WTP for the matched vendible item and the price to be paid for the matched vendible item.

For some embodiments, the matching maximizes the sum of the utilities for all customers, where customer utility for any unit of any of the vendible items to which said customer is matched is the difference between said customer's WTP for the matched vendible item and the price to be paid for the vendible item.

For other embodiments, the matching approximately maximizes the sum of the customer utilities; where customer utility for any of the vendible items to which the customer is matched is the difference between said customer's WTP for the matched item and the price to be paid for the item; and where approximate maximization permits a matching whose sum of customer utilities is no more than some threshold less than that of any other matching.

For some embodiments, the matching maximizes the sum of the utilities received by all customers, subject to the constraint that, if it matches a customer to one or more units of any of the vendible items then the match maximizes the customer's utility; where customer utility is the difference between said customer's WTP for the matched item and the price to be paid for the item.

For other embodiments, the matching approximately maximizes the sum of the utilities received by all customers, subject to the constraint that, if it matches a customer to one or more units of any of the at least two vendible items then the match maximizes the customer's utility; where customer utility is the difference between said customer's WTP for the matched item and the price to be paid for the item; and wherein the approximate maximization permits a matching whose sum of customer utilities is no more than some threshold less than that of any other matching.

In accordance with some embodiments, the matching is stable in that no customer would prefer to buy a different vendible item than the vendible item to which the respective customer is matched to in the matching.

At 210, matching machine 12 is operable making the matching electronically available, and may also complete purchases based on the matching and so on. The matching machine 12 may make the matching electronically available by outputting the matching or saving it to a shared memory, for example. The method 200 may further involve outputting a contract or payment terms or vouchers for purchase between any customer matched to one or more units of one or more goods or services and the vendors offering for sale any good or service to which said customer is matched, wherein said contract or payment terms or vouchers for purchase are based on the prices of the matching. As another example, the method 200 may further involve receiving payment from any customer matched to one or more units of one or more goods or services and the vendors offering for sale any good or service to which the customer is matched, wherein said payments are based on the prices of the matching; issuing vouchers for purchase for purchase to said customers for any matched products or services for which payment is received; and making payment to vendors of said products or services, wherein said payments are based on the prices of the matching and the payments received from customers.

In accordance with some embodiments, the customer preference set received from any customer comprises an ordering or ranking of one or more deals, where a deal is any combination of a vendible item together with a price for the item, wherein if a first deal is ranked higher than a second deal, then the first deal is preferred by said customer to the second deal.

In accordance with some embodiments, the matching matches a customer to one or more units of any of the at least two vendible items only if the match, given the price to be paid for the one or more units of any of the at least two vendible items, comprises a deal that is preferred to any other available deal, where an available deal consists of a second vendible item different from the matched item, and the price to be paid for said second vendible item determined by the matching.

As noted herein, at 204, matching machine 12 may receive from one or more customers a partial customer preference set, wherein said partial customer preference set indicates constraints on the possible WTP values for the customer for one of the vendible items. In accordance with such embodiments, the matching may be further based on selecting, for each customer providing partial customer preference set, a WTP value for each vendible item for said customer, the WTP value selected to be consistent with the partial customer preference set.

The method 200 may further involve determining if the matching satisfies some quality measure; if a termination condition is met, the termination condition comprising the quality measure computed, terminating with the matching; if the quality measure is not satisfied, selecting one or more of the at least two customers, and requesting additional partial customer preference sets from the customers; receiving additional partial customer preference sets in response to the requests; repeating the matching step based on all received customer preference sets; and possibly repeating the steps until the termination condition is met. The quality measure may be one of: expected total customer utility computed relative to some probability distribution over unknown willingness to pay (WTP) values for one or more customers for one or more of the at least two vendible items; an error bound on total customer utility computed relative to the unknown WTP values for one or more customers for the one or more vendible items. The termination condition may be one of: the quality measure of the matching exceeds some quality threshold; a maximum time limit for determining a matching is reached or exceeded; a maximum amount of additional customer preference sets has been received.

As noted herein, matching customers and vendors is a problem that may be address by embodiments described herein. An interesting variant of the matching problem may arise when self-interested customers come together in order to induce vendors to offer quantity or volume discounts, as is common in buying consortia, and more recently in the consumer group couponing space. Embodiments described herein may address a general model of this problem in which a group or buying consortium is faced with volume discount offers, or other pricing schedules comprising other types of offers such as those described herein, from multiple vendors, but group members have distinct preferences for different vendor offerings. Unlike some recent formulations of matching games that involve quantity discounts, the combination of varying preferences and discounts may render the core of the matching game empty, in both the transferable and nontransferable utility sense. Thus, instead of coalitional stability, embodiments described herein may involve several forms of stability, including myopic stability, or Nash stability, or group stability, under various epistemic and transfer/payment assumptions. Embodiments described herein may involve the computation of customer-welfare maximizing matchings and may show the existence of transfers (subsidized prices) of a particularly desirable form that support stable matchings. Embodiments described herein may involve a nontransferable utility model, and may admit stable matchings; and may involve a variant of the problem in which customers provide a simple preference ordering over “deals” rather than specific valuations—a model that is especially attractive in the consumer space—which may also admit stable matchings.

Embodiments described herein may provide a method of matching customers to items or services comprising: receiving from each of one or more vendors of said items or services, a base price for each item or service offered for sale by said vendor; receiving from at least one vendor a pricing schedule for at least one item or service offered for sale by said vendor, wherein each pricing schedule includes: one or more pricing conditions for said item or service; and for each of pricing condition, a corresponding (for example, discounted) price for said item or service; receiving from each of one or more customers, the customer preference set describing the customer's preferences for purchasing one or more units of the one or more items or services at one or more of the base price or the discounted prices received for said item or service; matching each of the one or more of customers to zero or more units of zero or more items or services based on the received customer preference sets and received pricing schedules; and outputting a price to be paid by each customer for any units of the goods or services to which said customer has been matched, based on the received customer preference sets and received pricing schedules.

In accordance with some embodiments, the method may further include outputting a contract or payment terms or vouchers for purchase between any customer matched to one or more units of one or more goods or services and the vendors offering for sale any good or service to which said customer is matched, wherein said contract or payment terms or vouchers for purchase are based on the prices determined by the matching. In accordance with some embodiments, the method may further include: receiving payment from any customer matched to one or more units of one or more goods or services and the vendors offering for sale any good or service to which said customer is matched, wherein said payments are based on the prices computed; issuing vouchers for purchase for purchase to said customers for any matched items or services for which payment is received; and making payment to vendors of said items or services, wherein said payments are based on the prices computed by the matching and the payments received from customers.

In accordance with some embodiments, the pricing conditions received for any item may be volume thresholds, indicating that the corresponding discounted price will be offered if the matching matches customers to at least the number of units of said item or service indicated by the volume threshold.

In accordance with some embodiments, the discounted prices received for any item may be absolute prices, said prices to be offered if the matching produced by the invention matches customers to at least the number of units indicated in the corresponding volume pricing condition for said item or service. In accordance with some embodiments, the discounted prices received for any item are percentage or fractional discounts, where said percentage or fractional discounts are applied to the base price of said item if the matching produced by the invention matches customers to at least the number of units indicated in the corresponding volume pricing condition for said item. In accordance with some embodiments, the price to be paid by a customer for each unit of any item to which said customer is matched is either a base price or one of the discounted prices for said item; and the price to be paid by each customer matched to at least one unit of said item is the same. In accordance with some embodiments, the price to be paid by a customer for each unit of any item to which said customer is matched is personalized, and may be different from the prices paid by other customers for each unit of said item, and may be different from the received base and any received discounted prices for said item.

In accordance with some embodiments, the customer preference sets received from any customer comprises a willingness to pay (WTP) value for each item.

In accordance with some embodiments, the matching, if it matches a customer to one or more units or one or more products or services, only matches said customer to one or more units of any item that maximizes said customer's utility; where customer utility is the difference between said customer's WTP for said matched item and the price to be paid for said item.

In accordance with some embodiments, the matching, if it matches a customer to one or more units or one or more products or services, only matches said customer to one or more units of any item that approximately maximizes said customer's utility; where customer utility is the difference between said customer's WTP for said matched item and the price to be paid for said item; and approximate maximization permits the matching of said customer to one or more units of an item whose utility is less than that of some other item by at most some threshold.

In accordance with some embodiments, the matching, if it matches a customer to one or more units or one or more products or services, only matches said customer to one or more units of any item that maximizes said customer's anticipated utility; where customer anticipated utility for one unit of any item is the difference between said customer's WTP for said matched item and the price to be paid for said item that would be output by the matching engine if said customer were to be matched to one or more units of said item.

In accordance with some embodiments, the matching, if it matches a customer to one or more units or one or more products or services, only matches said customer to one or more units of any item that approximately maximizes said customer's anticipated utility; where customer anticipated utility for one unit of any item is the difference between said customer's WTP for said matched item and the price to be paid for said item that would be output if said customer were to be matched to one or more units of said item; and approximate maximization permits the matching of said customer to one or more units of an item whose anticipated utility is less than that of some other item by at most some threshold.

In accordance with some embodiments, the matching maximizes the sum of the utilities of all customers; where customer utility for any unit of any item to which said customer is matched is the difference between said customer's WTP for said matched item and the price to be paid for said item.

In accordance with some embodiments, the matching approximately maximizes the sum of the customer utilities; where customer utility for any unit of any item to which said customer is matched is the difference between said customer's WTP for said matched item and the price to be paid for said item; and where approximate maximization permits a matching to be output whose sum of customer utilities is no more than some threshold less than that of any other matching.

In accordance with some embodiments, the price to be paid by a customer for each unit of any item to which said customer is matched is either a base price or one of the discounted prices for said item; and the price to be paid by each customer matched to at least one unit of said item is the same.

In accordance with some embodiments, the price to be paid by a customer for each unit of any item to which said customer is matched is personalized, and may be different from the prices paid by other customers for each unit of said item, and may be different from the received base and any received discounted prices for said item.

In accordance with some embodiments, personalized prices are computed by: computing subsidies to be paid to one or more customers for the one or more units of the one or more units to which said customer is matched, wherein this subsidy will be applied to reduce the base price or discounted price for each unit of said item to which said customer is matched by the amount of the subsidy computed for said customer; computing contributions to be paid by one or more customers for the one or more units of the one or more units to which said customer is matched, wherein this contribution will be applied to increase the base price or discounted price for each unit of said item to which said customer is matched by the amount of the subsidy computed for said customer; and where the total of all subsidies does not exceed the total of all contributions.

In accordance with some embodiments, the matching, if it matches a customer to one or more units or one or more products or services, only matches said customer to one or more units of any item that maximizes said customer's utility; where customer utility is the difference between said customer's WTP for said matched item and the personalized price to be paid for said item by said customer, where said personalized price is determined by applying a contribution or subsidy.

In accordance with some embodiments, the matching, if it matches a customer to one or more units or one or more products or services, only matches said customer to one or more units of any item that approximately maximizes said customer's utility; where customer utility is the difference between said customer's WTP for said matched item and the personalized price to be paid for said item by said customer, where said personalized price is determined by applying a contribution or subsidy; and approximate maximization permits the matching of said customer to one or more units of an item whose utility is less than that of some other item by at most some threshold.

In accordance with some embodiments, the personalized prices may minimize the total of all subsidies and contributions applied, subject to the constraint that each customer's utility is maximized.

In accordance with some embodiments, the personalized prices minimize the size of the largest subsidy or contribution applied, subject to the constraint that each customer's utility is maximized.

In accordance with some embodiments, the matching maximizes the sum of the utilities received by all customers, subject to the constraint that, if it matches a customer to one or more units or one or more products or services, only matches said customer to one or more units of any item that maximizes said customer's utility; where customer utility is the difference between said customer's WTP for said matched item and the price to be paid for said item.

In accordance with some embodiments, the matching approximately maximizes the sum of the utilities received by all customers, subject to the constraint that, if it matches a customer to one or more units or one or more products or services, only matches said customer to one or more units of any item that maximizes said customer's utility; where customer utility is the difference between said customer's WTP for said matched item and the price to be paid for said item; and where approximate maximization permits a matching whose sum of customer utilities is no more than some threshold less than that of any other matching.

In accordance with some embodiments, the customer preference sets received from any customer comprises an ordering or ranking of each deal, where a deal is any combination of an item together with an possible price for said item, where a possible price is either a base price or discounted price for said product of service; and if a first deal is ranked higher than a second deal, then the first deal is preferred by said customer to the second deal.

In accordance with some embodiments, the matching, if it matches a customer to one or more units or one or more products or services, only matches said customer to one or more units of any item that, given the price to be paid for said item, comprises a deal that is preferred to any other available deal, where an available deal consists of a second item different from the matched item, and the price to be paid for said second item. In accordance with some embodiments, the customer preference sets received from one or more customers in is partial, where said partial information indicates constraints on the possible WTP values for said customer for one or more products or services. In accordance with some embodiments, the matching is further based on selecting, for each customer providing partial customer preference sets, a WTP value for each item for said customer, said WTP value selected to be consistent with the partial customer preference sets received from said customer.

In accordance with some embodiments, the method further includes: determining if the matching satisfies some quality measure; if some termination condition is met, said termination condition possibly including said quality measure, terminating with the matching and the prices; if said quality measure is not satisfied, selecting one or more customers, and requesting additional partial customer preference sets from said customers; receiving additional partial customer preference sets in response to the requests issued; repeating steps based on all received customer preference sets; repeating steps until the termination condition is met. In accordance with some embodiments, the quality measure is one of: expected total customer utility computed relative to some probability distribution over unknown WTP values for one or more customers for one of more products or services; an error bound on total customer utility computed relative to the unknown WTP values for one or more customers for one of more products or services. In accordance with some embodiments, the termination condition is one of: the quality measure of the matching meets or exceeds some quality threshold; a maximum time limit for determining a matching is reached or exceeded; a maximum amount of additional customer preference sets has been received

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well known methods, procedures and components have not been described in detail so as not to obscure the embodiments described herein.

1. A computer implemented method of providing a matching of customer preference sets to vendible items, wherein the computer comprises a processor and a memory coupled to the processor and configured to store instructions executable by the processor to perform the method comprising:
receiving a pricing schedule for each of at least two vendible items, wherein at least one of the pricing schedules comprises at least one nontrivial pricing condition for the respective vendible item, and, for each pricing condition, a corresponding price for the respective vendible item;
receiving at least two customer preference sets from a customer group comprising at least one customer, wherein each customer preference set describes a customer preference for purchasing one or more units of at least one of the at least two vendible items;
determining an objective function, wherein the objective function measures utility of the customer group when one or more received customer preference sets is matched to zero or more units of zero or more vendible items of the at least two vendible items, wherein the objective function measures the utility based on the customer preference sets and the pricing schedules;
determining, using the objective function, an optimal matching of one or more customer preference sets to zero or more units of zero or more vendible item of the at least two vendible items, wherein the matching comprises, for each customer preference set that is matched to the one or more units of at least one vendible item, a price to be paid for the respective matched units, wherein the price is based on the pricing schedule for the respective matched at least one vendible item; and
making the matching electronically available.

2. The method of claim 1, wherein each customer preference set corresponds to a customer of the customer group, wherein utility of a customer is a value the customer realizes from purchasing the zero or more units matched to each customer preference set corresponding to that customer at the price to be paid for the respective matched units, wherein the utility of the customer group is based on the utility of the customers of the customer group.

3. The method of claim 1, wherein a customer preference set comprises a preference to purchase at least one vendible item over at least one other vendible item.

4. The method of claim 1, wherein the customer preference set comprises a preference to purchase at least one vendible item at a particular price over at least one other vendible item at a particular price.

5. The method of claim 1, wherein the objective function comprises one or more constraints to preclude one or more matchings of customer preference sets to units of vendible items from being an optimal matching.

6. The method of claim 5, wherein the constraints are selected from the group of constraints consisting of customer budgetary constraints, customer capacity constraints, vendible item capacity constraints, vendible item budgetary constraints.

7. The method of claim 2, wherein the objective function maximizes the utility of the customer group, wherein the utility of the customer group comprises a sum of utilities of all customers.

8. The method of claim 7, wherein a customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for the zero or more units matched to each of that customer's customer preference sets and the price to be paid for the respective matched units.

9. The method of claim 7, wherein the maximization is an approximate maximization which permits the utility of the customer group to be less than a maximum achievable utility of the customer group by at most some threshold.

10. The method of claim 7, wherein the objective function comprises one or more constraints to preclude one or more matchings of customer preference sets to units of vendible items from being an optimal matching.

11. The method of claim 7, wherein the customer group comprises at least two customers, wherein each customer is assigned a weight factor, wherein the weight factor of at least one customer is different than the weight factor of at least one other customer, wherein the utility of the customer group comprises a weighted sum of utilities of all customers of the customer group, wherein the weighted sum is based on the weight factors.

12. The method of claim 7, wherein the maximization is subject to a constraint that no customer would achieve a higher utility if at least one of the customer preference sets corresponding to that customer were matched to one or more units of one or more vendible items, different than the zero or more units matched to that customer preference set, at the price to be paid for the respective matched units.

13. The method of claim 12, where the maximization constraint is approximate such that the utility of a customer that would be attained by matching at least one of the customer preference sets corresponding to that customer to one or more units of one of more products, different than the zero or more units matched to that customer preference set, at the prices of the matching, is greater than the utility of the customer determined by the matching by no more than a threshold.

14. The method of claim 7, wherein the maximization is subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to the different items.

15. The method of claim 14, wherein the maximization constraint is approximate such that the utility of a customer that would be attained if at least one of the customer preference sets corresponding to that customer were matched to one or more units of one or more vendible items, different than the zero or more units matched to that customer preference set, at the prices of the different vendible items that would be paid had that customer preference set been matched to said different items, is greater than the utility of the customer determined by the matching by no more than a threshold.

16. The method of claim 7, wherein the maximization is subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items.

17. The method of claim 16, where the maximization constraint is approximate such that the utility that the group of two or more customers would individually or collectively achieve, if at least one customer preference set corresponding to each customer in the group were matched to one or more units of one or more vendible items, different than the zero or more units matched to said customer preference sets, at the prices of the different vendible items that would be paid had said customer preference set been matched to said different items, is greater than the individual or collective utility attained by the customers of the group determined by the matching by no more than a threshold.

18. The method of claim 7, wherein the price to be paid by for each unit of the at least two vendible items to which a customer preference set is matched is personalized, and may be different from other prices to be paid for each unit of the at least two vendible items by other customer preference sets, and may be different from the prices of the pricing schedule.

19. The method of claim 18, wherein the personalized prices are computed by: computing subsidies to be paid to one or more customers for the one or more units of the items to which one or more of the customer preference sets associated with the customer are matched, wherein this subsidy will be applied to reduce the price, for each unit of the matched vendible items, or collectively for all units, by the amount of the subsidies computed for said customer; computing contributions to be paid by one or more customers for the one or more units of the items to which one or more customer preference sets associated with the customer are matched, wherein these contributions will be applied to increase the price, for each unit of the matched vendible items, or collectively for all matched units, by the amount of the contributions computed for said customer; and where the total of all subsidies does not exceed the total of all contributions.

20. The method of claim 19, wherein the personalized prices are computed by transferring contributions and subsidies between customers, wherein the objective function minimizes a total of all contributions and subsidies transferred.

21. The method of claim 18, wherein the maximization is subject to a constraint that no customer would achieve a higher utility if at least one of the customer preference sets corresponding to that customer were matched to one or more units of one or more vendible items, different than the zero or more units matched to that customer preference set, at the price to be paid for the respective matched units.

22. The method of claim 18, wherein the maximization is subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to said different items.

23. The method of claim 18, wherein the maximization is subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items.

24. The method of claim 21, wherein the maximization constraint is approximate such that the utility that a customer that would attained if at least one of the customer preference sets corresponding to that customer were matched to one or more units of one or more vendible items, different than the zero or more units matched to that customer preference set, is greater than the utility of the customer determined by the matching by no more than a threshold.

25. The method of claim 2, wherein the objective function optimizes the utility of the customer group subject to a constraint that no customer would achieve a higher utility if at least one of the customer preference sets corresponding to that customer were matched to one or more units of one or more vendible items, different than the zero or more units matched to that customer preference set, at the price to be paid for the respective matched units.

26. The method of claim 25, where the optimization constraint is approximate such that a utility of the customer that would be attained by matching at least one of the customer preference sets corresponding to that customer to one or more units of one of more items, different than the zero or more units matched to that customer preference set, at the prices of the matching, is greater than the utility of the customer determined by the matching by no more than a threshold.

27. The method of claim 2, wherein the objective function optimizes the utility of the customer group subject to a constraint that no customer would achieve higher utility if at least one of the customer preference sets corresponding to that customer were matched to one or more units of one or more vendible items, different than the zero or more units matched to that customer preference set, at prices of the different vendible items that would be paid had that customer preference set been matched to said different items.

28. The method of claim 27, wherein the maximization constraint is approximate such that the utility of a customer that would be attained if at least one of the customer preference sets corresponding to that customer were matched to one or more units of one or more vendible items, different than the zero or more units matched to that customer preference set, at the prices of the different vendible items that would be paid had that customer preference set been matched to said different items, is greater than the utility of the customer determined by the matching by no more than a threshold.

29. The method of claim 2, wherein the objective function optimizes the utility of the customer group subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items that would be paid had said customer preference sets been matched to said different items.

30. The method of claim 29, where the optimization constraint is approximate such that the utility that the group of two or more customers would individually or collectively achieve, if at least one customer preference set corresponding to each customer in the group were matched to one or more units of one or more vendible items, different than the zero or more units matched to said customer preference sets, at the prices of the different vendible items that would be paid had said customer preference set been matched to said different items, is greater than the individual or collective utility attained by the customers of the group determined by the matching by no more than a threshold.

31. The method of claim 25, wherein the customer preference set comprises a willingness to pay (WTP) value for one or more units of at least one vendible item of the at least two vendible items, wherein the value the customer realizes from purchasing the zero or more units matched to each customer preference set corresponding to that customer is the difference between the WTP value for zero or more units matched to each customer preference set and the price to be paid for the respective matched units.

32. The method of claim 25, wherein the optimization is an approximate optimization which permits the utility of the customer group to be different than a best utility of the customer group by at most some threshold.

33. The method of claim 25, wherein the objective function comprises one or more constraints to preclude one or more matchings of customer preference sets to units of vendible items from being an optimal matching.

34. The method of claim 1, wherein a deal is a combination of one or more units of a vendible item and a particular price for the one or more units of the vendible item, wherein at least one customer preference set comprises at least one of a ranking, rating, and scoring of one or more deals, wherein the utility of a customer is based on the at least one of the ranking, rating and scoring of deals.

35. The method of claim 34, further comprising determining one or more available deals based on the pricing schedules received for the vendible items and the matching of each customer preference set to zero or more units of zero or more vendible items, wherein the objective function optimizes the utility of the customer group subject to a constraint that no customer would achieve a higher utility if at least one of the customer preference sets corresponding to that customer were matched to one or more units of one or more vendible items, different than the zero or more units matched to that customer preference set, at the price to be paid for the respective matched units corresponding to the available deals.

36. The method of claim 34, wherein the objective function optimizes the utility of the customer group subject to a constraint that no customer would achieve higher utility if at least one of the customer preference sets corresponding to that customer were matched to one or more units of one or more vendible items, different than the zero or more units matched to that customer preference set, at prices of the different vendible items corresponding to the deals that would have been available had that customer preference set been matched to said different items.

37. The method of claim 34, wherein the objective function optimizes the utility of the customer group subject to a constraint that no group of two or more customers would individually or collectively achieve higher utility if at least one customer preference set corresponding to each customer in the group were matched to one or more units of one or more vendible items, different than the zero or more units matched to said customer preference sets, at the prices of the different vendible items corresponding to the deals that would have been available had said customer preference sets been matched to said different items.

38. The method of claim 1, further including:
determining if the matching satisfies a quality measure;
determining if a termination condition is met, wherein the termination condition comprises the quality measure;
upon determining that the termination condition is met, terminating with the matching;
upon determining that the termination condition is not met, selecting one or more customers, and requesting additional customer preferences corresponding to at least one of customer preference sets associated with at least one of the selected customers;
receiving additional customer preferences in response to the requests and augmenting the customer preference sets corresponding to the requests with the received preferences;
repeating the matching and determining steps based on the existing and augmented customer preference sets;
repeating the steps until the termination condition is met.

39. The method of claim 39, wherein the quality measure is one of: expected total customer utility computed relative to some probability distribution over unknown willingness to pay (WTP) values for one or more of the at least two vendible items; an error bound on total customer utility computed relative to the unknown WTP values for the one or more vendible items.

40. The method of claim 39, wherein the termination condition is one of: the quality measure of the matching exceeds some quality threshold; a maximum time limit for determining a matching is reached or exceeded; a maximum amount of additional customer preference set has been received.

41. A system for matching customer preference sets associated with a customer group to vendible items, the system comprising one or more processors and a memory coupled to the processors and configured to store instructions executable by the processors to configure a matching machine to use an objective function to determine an optimal matching of one or more customer preference sets to zero or more units of zero or more vendible item of at least two vendible items, wherein each customer preference set describes a customer preference for purchasing one or more units of at least one of the at least two vendible items, wherein each of the at least two vendible items is associated with a pricing schedule, wherein the matching comprises, for each customer preference set that is matched to the one or more units of at least one vendible item, a price to be paid for the respective matched units, wherein the price is based on the pricing schedule for the respective matched at least one vendible item, wherein each pricing schedule comprises at least one nontrivial pricing condition for the respective vendible item, and, for each pricing condition, a corresponding price for the respective vendible item, and wherein the objective function measures utility of the customer group when one or more received customer preference sets is matched to zero or more units of zero or more vendible items of the at least two vendible items, wherein the objective function measures the utility based on the customer preference sets and the pricing schedules.
